(19) United States
(12) Patent Application Publication
(10) Pub. No.: US 2004/0246874 A1
(43) Pub. Date: Dec. 9, 2004

(54) Hologram coupled member and method for manufacturing the same, and hologram laser unit and optical pickup apparatus

(75) Inventors: Terukazu Takagi, Kitakatsuragi-gun (JP); Kazunori Matsubara, Shiki-gun (JP)

Correspondence Address: MORRISON & FOERSTER LLP, 755 PAGE MILL RD, PALO ALTO, CA, 94304-1018, US

(73) Assignee: SHARP KABUSHIKI KAISHA, Osaka-shi (JP)

(21) Appl. No.: 10/840,885

(22) Filed: May 7, 2004

(30) Foreign Application Priority Data
May 8, 2003 (JP) P2003-130493
Apr. 12, 2004 (JP) P2004-116858

(51) Int. Cl. G11B 7/00

(52) U.S. Cl. 369/112.15; 369/112.1

(57) ABSTRACT

After a birefringent layer having a diffraction surface is formed on a light transmitting substrate and an isotropic overcoat layer is formed on the diffraction surface of the birefringent layer, the light transmitting substrate is formed on the isotropic overcoat layer, whereby first and second polarizing hologram substrates are formed. Between respective surfaces of the first and second polarizing hologram substrates facing each other, a light transmitting adhesive is applied uniformly, and the first polarizing hologram substrate and the second polarizing hologram substrate are adhered. Thus, a hologram coupled member in which an optical coupling layer formed as a result of cure of the light transmitting adhesive is interposed is formed between the mutually facing surfaces of the first and second polarizing hologram substrates.

### BACKGROUND OF THE INVENTION

1. Field of the Invention

The present invention relates to a hologram coupled member and a method for manufacturing the same, and a hologram laser unit and an optical pickup apparatus, which are preferably used when reading information of an optical recording medium such as a CD (Compact Disk) and a DVD (Digital Versatile Disk) and recording information onto the optical recording medium.

2. Description of the Related Art

An optical pickup apparatus is used for reading and recording information from and on to an optical disk-shaped recording medium (hereinafter, simply referred to as an ‘optical recording medium’). Since before, an optical recording medium called a CD (Compact Disk) family which information is read from and written in by the use of only light has been used, and at the time of reading and recording information from and on to this optical recording medium, a semiconductor laser device which emits a laser light beam of an infrared wavelength whose oscillation wavelength is 780 nm is used.

In recent years, an optical recording medium called a DVD (Digital Versatile Disk) family which information is read from and written in by the use of light and magnetism and which allows recording of more information than the CD family also comes to be used in large quantities, and at the time of reading and recording information from and onto this optical recording medium, a semiconductor laser device which emits a laser light beam of an infrared wavelength whose oscillation wavelength is 630 nm to 690 nm is used. Therefore, an optical pickup apparatus which is capable of reading and recording information from and onto both the optical recording mediums of the CD family and the DVD family is demanded, and is being developed.

In a first related art such as Japanese Unexamined Patent Publication JP-A 9-73017 (1997), an optical pickup apparatus is provided with two light sources which emit laser light beams of different oscillation wavelengths and one hologram device designed so that the efficiency of light use of a laser light beam of a short oscillation wavelength becomes large, and structured so as to be capable of finely playing back both an optical recording medium of relatively high recording density to be played back by the use of a laser light beam of a short wavelength, such as a DVD, and an optical recording medium of relatively low recording density to be played back by the use of a laser light beam of a long wavelength, such as a CD.

In a second related art such as Japanese Unexamined Patent Publication JP-A 9-120568 (1997), a laser module in which two semiconductor laser diodes whose oscillation wavelengths are different from each other and an optical element for condensing laser light beams emitted from the semiconductor laser diodes, respectively, onto an information record surface of an optical recording medium are integrated in a single body, whereby reproduction and record of information from and onto plural standards of optical recording mediums is enabled.

In a third related art such as Japanese Unexamined Patent Publication JP-A 2000-76689, a first semiconductor laser device which emits a laser light beam whose oscillation wavelength is 650 nm, a second semiconductor laser device which emits a laser light beam whose oscillation wavelength is 780 nm and a light-receiving device are installed in a single package. A first light transmitting substrate is mounted above the package, and a three-beam diffraction grating and a hologram device for diffracting only the laser light beam emitted from the first semiconductor laser device are formed on the first light transmitting substrate. Moreover, a second light transmitting substrate is mounted above the first light transmitting substrate, and a hologram device for diffracting only the laser light beam emitted from the second semiconductor laser device is formed on the second light transmitting substrate. Light obtained when the laser light beam emitted from the first semiconductor laser device is reflected by an optical recording medium is diffracted and guided to the light-receiving device by the hologram device on the second light transmitting substrate, and light obtained when the laser light beam emitted from the second semiconductor laser device is reflected by an optical recording medium is diffracted and guided to the light-receiving device by the hologram device on the first light transmitting substrate.

In a fourth related art such as Japanese Unexamined Patent Publication JP-A 2002-72143, an optical pickup apparatus is provided with a first hologram which has a first hologram diffraction grating formed on a surface thereof, and a second hologram which has a second hologram diffraction grating formed on a surface thereof and is mounted on the first hologram so as to cover the first hologram diffraction grating. The surface area of the first hologram on a side of the second hologram is larger than the surface area of the second hologram on a side of the first hologram.

When the second hologram is mounted on the first hologram, firstly, in a position on the surface of the first hologram which corresponds to each apex of the second hologram on the first hologram side, the second hologram is placed after an ultraviolet cure resin (abbreviated as a UV resin) is dropped, and temporarily secured by irradiating the UV resin with an ultraviolet ray after an optical adjustment. Secondly, the UV resin is applied to a portion not in contact with the second hologram of the surface of the first hologram and a lower portion of a side surface of the second hologram, and the UV resin is irradiated with the ultraviolet ray, whereby the second hologram is secured on the first hologram.

In a fifth related art such as Japanese Unexamined Patent Publication JP-A 2002-279683, a first hologram substrate and a second hologram substrate are disposed in a single body. The first and second hologram substrates have a focus detecting hologram portion and a track detecting strip hologram portion. After the second hologram substrate is mounted on the first hologram substrate, and an optical axis adjustment and an offset adjustment are performed, the first hologram substrate and the second hologram substrate are adhered and secured by an adhesive to become a single body. At this moment, the adhesive is applied to portions through which a laser light beam emitted from a light source does not pass of the first and second hologram substrates and a side surface of the second hologram substrate, whereby the first hologram substrate and the second hologram substrate are adhered to become a single body.

In the aforementioned fourth and fifth related arts, at the time of integrating the two hologram substrates, the adhesive is applied to, not the surfaces of the hologram substrates through which the laser light beam emitted from the light source pass, but the side face and the like of the hologram substrates through which the laser light beam does not pass, to adhere and secure the two hologram substrates, with the result that a gap is left between the two hologram substrates. A state that the gap is left described above can be considered to be a state that an air layer is interposed between the two hologram substrates. In the state that the air layer is interposed, when the laser light beam emitted from the light source enters the air layer, there is a case that a refraction index of the incident laser light beam changes. Moreover, there is a case that floating matters existing in the air layer scatters the laser light beam.

In a case where the air layer is interposed between the two hologram substrates as described above, there is a problem that refraction and scattering of light reduces the light amount of the laser light beam to be condensed onto the optical recording medium naturally, and causes light amount loss, whereby reliability is lowered.

Further, in the aforementioned third to fifth related arts, two semiconductor laser devices are placed adjacent to each other in a position such that optical axes of laser light beams emitted from the respective semiconductor laser devices become nearly coincide so that the laser light beams of different oscillation wavelengths emitted from the two semiconductor laser devices, respectively, enter both first and second hologram devices, and therefore, there is a problem such that, resulting from the diffraction of the laser light beams emitted from the respective semiconductor laser devices by the first and second hologram devices, unnecessary light is generated and the amount of laser light beams which should be condensed to an optical recording medium decreases, whereby the efficiency of the use of light lowers.

In order to solve these problems, it is required to make the dimensions in thickness directions of diffraction grating grooves formed on the three-beam diffraction grating and the second hologram device to be dimensions such that only a laser light beam emitted from the second semiconductor laser device is diffracted, and make the dimension in a thickness direction of a diffraction grating groove formed on the first hologram device to be a dimension such that only a laser light beam emitted from the first semiconductor laser device is diffracted. However, since pitches of the diffraction gratings of the first and second hologram devices are small as compared with that of the three-beam diffraction grating, it is difficult to provide the first and second hologram devices with diffraction grating grooves having dimensions such that only one of the laser light beams emitted from the two semiconductor laser devices is diffracted.

### SUMMARY OF THE INVENTION

An object of the invention is to provide a hologram coupled member and a method for manufacturing the same, a hologram laser unit and an optical pickup apparatus, which are capable of increasing reliability.

The invention provides a hologram coupled member comprising:

a first substrate on which a first optical element having a diffraction surface is formed;

a second substrate on which a second optical element having a diffraction surface is formed; and

an optical coupling layer interposed between respective surfaces of the first and second substrates facing each other.

Further, in the invention, the first substrate includes an isotropic overcoat layer formed on the diffraction surface of the first optical element; and

the second substrate includes an isotropic overcoat layer formed on the diffraction surface of the second optical element.

Further, in the invention, a refraction index of the optical coupling layer is almost equal to a refraction index of the isotropic overcoat layer.

Further, the invention provides a method for manufacturing a hologram coupled member comprising the steps of:

forming a first optical element having a diffraction surface on a first substrate;

forming a second optical element having a diffraction surface on a second substrate; and

interposing an optical coupling layer between respective surfaces of the first and second substrates facing each other.

Further, in the invention, the method further comprises the steps of:

forming an isotropic overcoat layer on the diffraction surface of the first optical element; and

forming an isotropic overcoat layer on the diffraction surface of the second optical element.

Further, in the invention, the method further comprises the step of uniformly applying a light transmitting adhesive between the respective surfaces of the first and second substrates facing each other and adhering the first substrate and the second substrate.

Further, the invention provides an optical pickup apparatus comprising:

the hologram coupled member,

wherein the first and second optical elements have diffraction characteristics of diffracting reflection light beams of transmission light beams transmitted in one direction to a common region.

Further, in the invention, the apparatus further comprises a polarizing element which functions as an almost one-quarter wavelength plate for light beams of plural wavelengths.

Still further, in the invention, the optical coupling layer is made of a light transmitting solid material.

Still further, in the invention, the first optical element is a nonpolarizing hologram diffraction grating whose diffraction efficiency is nearly constant regardless of a polarization direction of incident light, and the second optical element is a polarizing hologram diffraction grating whose diffraction efficiency varies depending on a polarization direction of incident light.

Still further, in the invention, the first substrate is joined to a surface of a semiconductor laser apparatus in a state where a peripheral region thereof is exposed, the optical coupling layer is joined to a surface of the first substrate in a state where a peripheral region thereof is exposed, and the second substrate is joined to a surface of the optical coupling layer in a state where a peripheral region thereof is exposed.

Still further, in the invention, a beam splitting diffraction grating is formed on a surface of the first substrate, the surface being opposite to a surface on which the first optical element is formed.

Still further, in the invention, the beam splitting diffraction grating splits incident light into one main beam and two sub beams.

Still further, in the invention, the hologram coupled member further comprises a light transmitting phase difference film which gives different phase differences to respective light beams of first and second wavelength bands,

wherein the phase difference film is integrally formed with the second substrate.

Still further, the invention provides a hologram laser unit comprising:

a light source which emits light beams of predetermined plural wavelength bands;

a light receiving device which receives a light beam emitted from the light source and reflected by an optical recording medium; and

the hologram coupled member,

wherein the first and second optical elements have a diffraction characteristic such that the optical elements diffract reflection light of transmission light transmitted in one direction, to a specified common region of the light receiving device.

Still further, the invention provides an optical pickup apparatus comprising:

a light source which emits light beams of predetermined plural wavelength bands;

condensing means which condenses a light beam emitted from the light source to an optical recording medium;

a light receiving device which receives a light beam condensed to the optical recording medium by the condensing means and reflected by the optical recording medium;

the hologram coupled member; and

a light transmitting phase difference film which gives different phase differences to respective light beams of first and second wavelength bands emitted from the light source and transmitted by the hologram coupled member,

wherein the phase difference film is placed between the second substrate and the condensing means.

Still further, in the invention, the beam splitting diffraction grating formed on the first substrate of the hologram coupled member splits incident light into one main beam and two sub beams, and gives a phase difference to one of the sub beams so that the amplitude of a difference signal of the two sub beams becomes nearly zero.

According to the invention, the first optical element having the diffraction surface is formed on the first substrate, and the second optical element having the diffraction surface is formed on the second substrate. The optical coupling layer is interposed between the respective surfaces of the first and second substrates facing each other.

In the case of using, for example, a cured material of the light transmitting adhesive as the optical coupling layer, by interposing the optical coupling layer between the respective surfaces of the first substrate and the second substrate facing each other as described above, it is possible to prevent that a gap is left between the first substrate and the second substrate and an air layer is interposed as in the related art. Thus, it is avoided that a refraction index changes with a change in temperature and humidity as in the related art, and it is possible to transmit a light beam from the first substrate which light beam enters the optical coupling layer, to the second substrate. Therefore, compared with in the related art, it is possible to reduce light amount loss which occurs because a light beam light to be condensed on an optical recording medium is not condensed because of refraction of light. Consequently, it is possible to increase reliability.

Further, in the case of using silica glass, acrylic resin or the like as the optical coupling layer, by interposing the optical coupling layer between the respective surfaces of the first and second substrates, the surfaces facing each other, as described above, it is possible to prevent that light diffracted by a diffraction surface of the second optical element formed on the second substrate enters and is diffracted by a diffraction surface of the first optical element formed on the first substrate. Moreover, in the case of using the second optical element to execute an optical adjustment such as an optical axis adjustment for plural light beams of different wavelength bands, by mounting and fixing the optical coupling layer on the first substrate in advance, it is possible to prevent that the diffraction surface of the first optical element formed on the first substrate is damaged by a rotating movement of the second substrate.

According to the invention, the isotropic overcoat layer is formed on each of the diffraction surfaces of the first and second optical elements. Since the isotropic overcoat layer is made of a material having an isotropic refraction index, the isotropic overcoat layer is capable of transmitting incident light without changing the refraction index of the incident light. Therefore, it is possible to reduce light amount loss which occurs because a light beam to be condensed on the optical recording medium is not condensed because of refraction of light. Consequently, it is possible to increase reliability.

According to the invention, the refraction index of the optical coupling layer is almost equal to the refraction index of the isotropic overcoat layer, with the result that it is possible to substitute the optical coupling layer for the isotropic overcoat layer of the first substrate. Thus, it is possible to omit the step of forming the isotropic overcoat layer of the first substrate, whereby it is possible to reduce man-hours of manufacture. Moreover, reduction of the man-hours of manufacture facilitates the manufacture of the hologram coupled member. Furthermore, reduction of the man-hours of manufacture allows reduction of the cost for manufacturing the hologram coupled member.

According to the invention, the light transmitting adhesive is uniformly applied between the respective surfaces of the first and second substrates facing each other, and the first substrate and the second substrate are adhered. This makes it possible to prevent that a gap is left between the first substrate and the second substrate and an air layer is interposed as in the related art. Since the adhesive used for adhering the first substrate and the second substrate is a light transmitting adhesive, the adhesive is capable of transmitting a light beam from the first substrate to the second substrate. Thus, it is possible to reduce light amount loss which occurs because a light beam to be condensed on the optical recording medium is not condensed because of refraction or scattering of light. Consequently, it is possible to increase reliability.

Still further, according to the invention, the first and second optical elements have a diffraction characteristic such that the optical elements diffract reflection light of transmission light transmitted in one direction, to a common region. Therefore, for example, by placing a light receiving device in the common region where the reflection light is diffracted, it is possible to cause the light receiving device to receive light beams diffracted by the first and second optical elements, and easily detect signals necessary for reading information of a DVD and a CD and recording information on a DVD and a CD, for example.

According to the invention, the optical pickup apparatus is provided with the polarizing element which functions as the almost one-quarter wavelength plate for light beams of plural different wavelengths. Thus, it is possible to share the polarizing element which functions as the almost one-quarter wavelength plate for the light beams of plural different wavelengths, with the result that it is possible to increase the efficiency of light use with respect to the light beams of plural different wavelengths without increasing the number of parts of the optical pickup apparatus. Moreover, by increasing the efficiency of light use with respect to the light beams of plural wavelengths, it is possible to, for example, read information of the DVD and the CD and record information onto the DVD and the CD accurately.

Still further, according to the invention, by forming the optical coupling layer by a light transmitting solid material such as silica glass and acrylic resin, it is possible to decrease scattering of light and attenuation of light as much as possible, and transmit light guided from the first substrate and guide the light to the second substrate. Moreover, by forming the optical coupling layer by the solid material, it is possible to prevent deformation and distortion of an optical component such as the first and second substrates, and avoid that deviation of an optical axis occurs.

Still further, according to the invention, the first optical element formed on the first substrate is a nonpolarizing hologram diffraction grating whose diffraction efficiency is nearly constant regardless of a polarization direction of incident light, and the second optical element formed on the second substrate is a polarizing hologram diffraction grating whose diffraction efficiency varies depending on a polarization direction of incident light. By forming the nonpolarizing hologram diffraction grating and the polarizing hologram diffraction grating on the first substrate and the second substrate, respectively, as described above, it is possible to diffract and transmit only incident light of a specified polarization direction, in a specified direction, on the basis of a polarization direction of the incident light. Therefore, it is possible to prevent that the efficiency of the use of light decreases because of diffraction of incident light in an undesired direction as in the related art.

Still further, according to the invention, the first substrate is joined to a surface of a semiconductor laser apparatus in a state where a peripheral region thereof is exposed, the optical coupling layer is joined to a surface of the first substrate in a state where a peripheral region thereof is exposed, and the second substrate is joined to a surface of the optical coupling layer in a state where a peripheral region thereof is exposed. Therefore, by applying, for example, a light transmitting adhesive to a corner portion where the peripheral region of the semiconductor laser apparatus and an outer peripheral surface of the first substrate, the outer peripheral surface facing the peripheral region of the semiconductor laser apparatus, cross each other, it is possible to adhere the semiconductor laser apparatus and the first substrate. Moreover, by applying, for example, a light transmitting adhesive to a corner portion where the peripheral region of the first substrate and an outer peripheral surface of the optical coupling layer, the outer peripheral surface facing the peripheral region of the first substrate, cross each other, it is possible to adhere the first substrate and the optical coupling layer. Furthermore, by applying, for example, a light transmitting adhesive to a corner portion where the peripheral region of the optical coupling layer and an outer peripheral surface of the second substrate, the outer peripheral surface facing the peripheral region of the optical coupling layer, cross each other, it is possible to adhere the optical coupling layer and the second substrate.

Further, by joining the first substrate to a surface of the semiconductor laser apparatus in a state where a peripheral region thereof is exposed, joining the optical coupling layer to a surface of the first substrate in a state where a peripheral region thereof is exposed, and joining the second substrate to a surface of the optical coupling layer in a state where a peripheral region thereof is exposed, it is possible to secure regions for applying an adhesive in order to adhere the semiconductor laser apparatus and the first substrate, adhere the first substrate and the optical coupling layer, and adhere the optical coupling layer and second substrate. Therefore, only by applying an adhesive to the respective secured regions, it is possible to easily adhere the semiconductor laser apparatus and the first substrate, adhere the first substrate and the optical coupling layer, and adhere the optical coupling layer and the second substrate, whereby it is possible to facilitate an adhering operation.

Still further, according to the invention, the beam splitting diffraction grating is formed on a surface of the first substrate, the surface being opposite to a surface on which the first optical element is formed. By thus forming the beam splitting diffraction grating on the first substrate where the first optical element is formed, it is possible to reduce the number of optical components as compared with when the beam splitting diffraction grating is disposed singly. Moreover, for example, in the case of using a hologram coupled member that the number of optical components is reduced, in an optical pickup apparatus, it is possible to reduce the size and weight of the optical pickup apparatus, and it is possible to decrease the cost of manufacture of the optical pickup apparatus.

Still further, according to the invention, the beam splitting diffraction grating splits incident light into one main beam and two sub beams. By causing the beam splitting diffraction grating to split incident light into one main beam and two sub beams in this manner, it is possible to correct deviation of light condensed to the optical recording medium from the center of a track, for example, on the basis of signals outputted when the main beam and the sub beams are reflected by the optical recording medium and received by the light receiving device, and obtain a tracking error signal used for causing light to follow the track accurately.

Still further, according to the invention, the phase difference film is integrally formed with the second substrate. By integrally forming the phase difference film and the second substrate in this manner, the number of optical components and the number of steps in assembly at the time of manufacture are reduced, and an operation of an optical adjustment such as an optical axis adjustment is simplified. Moreover, for example, in the case of using a hologram coupled member that the number of optical components is reduced, in an optical pickup apparatus, it is possible to reduce the size of the optical pickup apparatus, and it is possible to decrease the cost of manufacture of the optical pickup apparatus.

Still further, according to the invention, the first and second optical elements have a diffraction characteristic such that the optical elements diffract reflection light of transmission light transmitted in one direction, to a specified common region of the light receiving device. Therefore, it is possible to cause the light receiving device to receive light beams diffracted by the first and second optical elements, thereby easily detecting signals necessary for reading information of a CD and a DVD and recording information on a CD and a DVD, for example.

Still further, according to the invention, a light transmitting phase difference film which gives different phase differences to respective light beams of first and second wavelength bands emitted from the light source is placed between the second substrate and the condensing means. The phase difference film gives a phase difference of almost 90 degrees to the light beam of the first wavelength band, and gives a phase difference of almost 360 degrees to the light beam of the second wavelength band, for example. The light beam of the first wavelength band, which is linearly polarized, is converted to a circularly polarized light beam when entering the phase difference film. When this circularly polarized light beam is condensed to the optical recording medium by the condensing means, and thereafter, reflected by the optical recording medium to enter the phase difference film again, the light beam is converted to a linearly polarized light beam whose polarization direction is orthogonal to that of the light beam before condensed to the optical recording medium. Moreover, even when the light beam of the second wavelength band, which is linearly polarized, enters the phase difference film, the light beam is transmitted as a linearly polarized light beam. Even when this linearly polarized light beam is condensed to the optical recording medium by the condensing means, and reflected by the optical recording medium to enter the phase difference film again, the light beam is transmitted by the phase difference film as a linearly polarized light beam whose polarization direction is identical to that of the light beam before condensed to the optical recording medium.

By placing the light transmitting phase difference film between the second substrate and the condensing means as described above, it is possible to give phase differences to the respective light beams of the first and second wavelength bands emitted from the light source, and execute an adjustment in a polarization direction for the respective light beams. Moreover, since it is possible to use the phase difference film in common for the light beams of the first and second wavelength bands, it is possible, without increasing the number of optical components of an optical pickup apparatus, to prevent generation of unnecessary light resulting from, for example, diffraction of light as much as possible, and prevent decrease of the efficiency of the use of light. Consequently, it is possible to accurately read information of a CD and a DVD and record information on a CD and a DVD, for example.

Still further, according to the invention, the beam splitting diffraction grating formed on the first substrate of the hologram coupled member splits incident light into one main beam and two sub beams, and gives a phase difference to one of the sub beams so that the amplitude of a difference signal of the two sub beams becomes nearly zero. By thus using the beam splitting diffraction grating for giving a phase difference to one of the sub beams so that the amplitude of a difference signal of the two sub beams becomes nearly zero, even in the case of using optical recording mediums of different track pitches, it is possible to, for example, counter vail an offset caused by a shift of an objective lens and a tilt of a disk, without lowering the efficiency of the use of light, when detecting a tracking error signal. Consequently, it is possible to cause the objective lens to follow the eccentricity of the optical recording medium, and execute stable tracking servo such that the main beam and the sub beams split by the beam splitting diffraction grating trace on aimed tracks at all times. Moreover, by using the beam splitting diffraction grating for giving a phase difference to one of the sub beams so that the amplitude of a difference signal of the two sub beams becomes nearly zero, the need for rotating and adjusting the diffraction grating to adjust the position of the sub beam is eliminated, and it is possible to facilitate an assembly adjustment of the optical pickup apparatus.

### BRIEF DESCRIPTION OF THE DRAWINGS

Other and further objects, features, and advantages of the invention will be more explicit from the following detailed description taken with reference to the drawings wherein:

FIG. 1 is a simplified perspective view showing a structure of a hologram laser unit including a hologram coupled member of one embodiment of the invention;

FIG. 2 is a simplified view showing a structure of the optical pickup apparatus;

FIG. 3 is a cross sectional view showing a first polarizing hologram substrate;

FIGS. 4A to 4C are views for describing the steps in manufacture of the first polarizing hologram substrate;

FIG. 5 is a cross sectional view showing a hologram coupled member;

FIGS. 6A and 6B are views for describing the steps in manufacture of a hologram coupled member;

FIG. 7 is a cross sectional view showing the hologram coupled member;

FIGS. 8A and 8B are views showing first and second polarizing hologram diffraction gratings, and a light-receiving device which receives light beams diffracted by the first and second polarizing hologram diffraction gratings;

FIGS. 9A and 9B are views showing the first and second polarizing hologram diffraction gratings, and the light-receiving device which receives the light beams diffracted by the first and second polarizing hologram diffraction gratings;

FIG. 10 is a simplified perspective view showing a structure of a hologram laser unit comprising the hologram coupled member, which is another embodiment of the invention;

FIG. 11 is a simplified view showing a structure of the optical pickup apparatus;

FIG. 12 is a simplified perspective view showing a structure of a hologram laser unit comprising a hologram coupled member, which is still another embodiment of the invention;

FIG. 13 is a simplified view showing a structure of an optical pickup apparatus;

FIG. 14 is a cross sectional view showing a polarizing hologram substrate;

FIGS. 15A and 15B are views showing a nonpolarizing hologram diffraction grating and a polarizing hologram diffraction grating, and a light receiving device for receiving light beams diffracted by the nonpolarizing hologram diffraction grating and the polarizing hologram diffraction grating, respectively;

FIGS. 16A and 16B are views showing the nonpolarizing hologram diffraction grating and the polarizing hologram diffraction grating, and the light receiving device for receiving light beams diffracted by the nonpolarizing hologram diffraction grating and the polarizing hologram diffraction grating, respectively;

FIG. 17 is a simplified perspective view showing a structure of a hologram laser unit comprising the hologram coupled member, which is still another embodiment of the invention; and

FIG. 18 is a simplified view showing a structure of an optical pickup apparatus.

### DETAILED DESCRIPTION

Now referring to the drawings, preferred embodiments of the invention are described below.

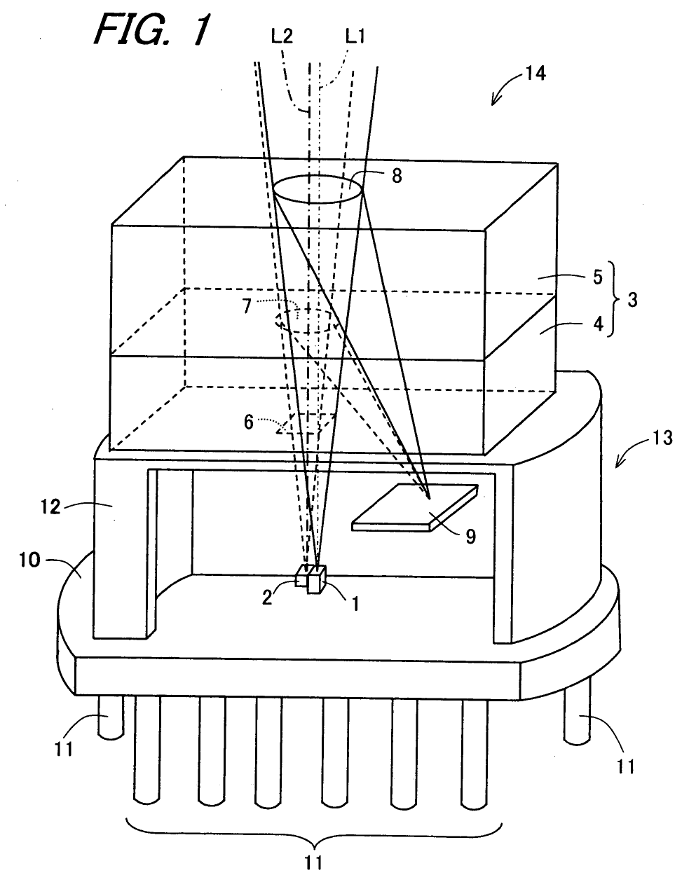

FIG. 1 is a simplified perspective view showing a structure of a hologram laser unit 14 including a hologram coupled member 3 of one embodiment of the invention. In FIG. 1, a cap 12 described later is partially cut away to show. The hologram laser unit 14 comprises the hologram coupled member 3 and a semiconductor laser apparatus 13. The semiconductor laser apparatus 13 includes a first semiconductor laser device 1, a second semiconductor laser device 2, a light receiving device 9, a stem 10, an electrode 11, and a cap 12. The hologram coupled member 3 includes a first polarizing hologram substrate 4 serving as the first substrate, and a second polarizing hologram substrate 5 serving as the second substrate. The first polarizing hologram substrate 4 includes a three-beam diffraction grating 6 and a first polarizing hologram diffraction grating 7 which serves as the first optical element, and the second polarizing hologram substrate 5 includes a second polarizing hologram diffraction grating 8 serving as the second optical element.

The first semiconductor laser device 1 emits a laser light beam of an infrared wavelength whose oscillation wavelength is, for example, 650 nm. The first semiconductor laser device 1 is used for reading information recorded on an information record surface of a DVD (Digital Versatile Disk), for example. The second semiconductor laser device 2 emits a laser light beam of an infrared wavelength whose oscillation wavelength is, for example, 780 nm. The second semiconductor laser device 2 is used for reading information recorded on the information record surface of a CD (Compact Disk) and recording information on to the information record surface, for example. The first and second semiconductor laser devices 1, 2 are placed adjacent to each other in a direction perpendicular to an optical axis L1 of a laser light beam emitted from the first semiconductor laser device 1 and an optical axis L2 of a laser light beam emitted from the second semiconductor laser device 2, and mounted on one surface portion in a thickness direction of the stem 10 formed like a plate. The optical axis L1 of the laser light beam emitted from the first semiconductor layer device 1 and the optical axis L2 of the laser light beam emitted from the second semiconductor layer device 2 are parallel to each other.

The three-beam diffraction grating 6 diffracts an incident laser light beam, thereby dividing into one main beam and two sub beams. The first and second polarizing hologram diffraction gratings 7, 8 have different diffraction efficiency according to the polarization direction of the incident light. The first and second polarizing hologram diffraction grating 7, 8 have diffraction characteristics such that the diffraction efficiency for the light in the predetermined first polarization direction is relatively increased, and the diffraction efficiency for the light in the second polarization direction orthogonal to the first polarization direction is reduced. In the embodiment, light beams of a first polarization direction emitted from the first and second semiconductor laser devices 1, 2 and entering the first and second polarizing hologram diffraction gratings 7, 8 are transmitted without being diffracted. Moreover, after light beams transmitted by the first and second polarizing hologram diffraction gratings 7, 8 pass through a one-quarter wavelength plate 23 described later and are condensed to an optical recording medium, the light beams are reflected by the optical recording medium and pass through the one-quarter wavelength plate 23 again, whereby the polarization direction is converted to a second polarization direction which is orthogonal to the first polarization direction, and the light beams enter the first and second polarizing hologram diffraction gratings 7, 8. Light beams whose polarization direction is converted from the first polarization direction to the second polarization direction are diffracted in a predetermined diffraction direction by the first and second polarizing hologram diffraction gratings 7, 8.

The first and second polarizing hologram diffraction gratings 7, 8 are optimized for, of the two light beams of different wavelengths emitted from the first and second semiconductor laser devices 1, 2, only one of the light beams or both the light beams. The polarizing hologram diffraction grating optimized for only one of the light beams sometimes causes light amount loss when transmitting another light beam. In this case, it is good to optimize the polarizing hologram diffraction grating for a light beam used for an optical recording medium which requires writing. Thus, it is possible to minimize the light amount loss of the laser light beam necessary for writing.

The light-receiving device 9, which is realized by a photodiode or the like, converts incident light to electric signals. The cap 12, which is a sealing member for sealing the first and second semiconductor laser devices 1, 2 and the light receiving device 9 in order to avoid physical contact of the first and second semiconductor laser devices 1, 2 and the light receiving device 9 with the outside, is mounted to one surface of the stem 10. Thus, the first and second semiconductor laser devices 1, 2 and the light-receiving device 9 are hermetically sealed by the stem 10 and the cap 12. The electrode 11 is disposed so as to protrude from another surface portion in the thickness direction of the stem 10 toward another side in the thickness direction, and electrically connected to the first and second semiconductor laser devices 1, 2.

The first polarizing hologram substrate 4 formed into a rectangular parallelepiped is mounted on the semiconductor laser apparatus 13. Describing in detail, the first polarizing hologram substrate 4 is mounted on one surface portion of the cap 12, the surface portion being perpendicular to the optical axes L1, L2. The three-beam diffraction grating 6 is formed on another surface portion in a thickness direction of the first polarizing hologram substrate 4, and the first polarizing hologram diffraction grating 7 is formed on a surface portion opposite to the surface portion where the three-beam diffraction grating 6 is formed, that is, on one surface portion in a thickness direction of the first polarizing hologram substrate 4. The second polarizing hologram substrate 5 formed into a rectangular parallelepiped is mounted on the one surface portion in the thickness direction of the first polarizing hologram substrate 4. The second polarizing hologram diffraction grating 8 is formed on a surface portion of the second polarizing hologram substrate 5, the surface portion being opposite to the surface joined to the first polarizing hologram substrate 4, that is, on one surface portion in a thickness direction of the second polarizing hologram substrate 5.

In the embodiment, the surface of the cap 12 facing the first polarizing hologram substrate 4, the surface of the second polarizing hologram substrate 4 facing the cap 12, the surface of the first polarizing hologram substrate 4 facing the second polarizing hologram substrate 5, and the surface of the second polarizing hologram substrate 5 facing the first polarizing hologram substrate 4 are plane surfaces, respectively, and are mutually parallel. Moreover, the optical axes L1, L2 of the laser light beams emitted from the first and second semiconductor laser devices 1, 2, respectively, are perpendicular to the surface of the cap 12 facing the first polarizing hologram substrate 4, the surface of the second polarizing hologram substrate 4 facing the cap 12, the surface of the first polarizing hologram substrate 4 facing the second polarizing hologram substrate 5, and the surface of the second polarizing hologram substrate 5 facing the first polarizing hologram substrate 4.

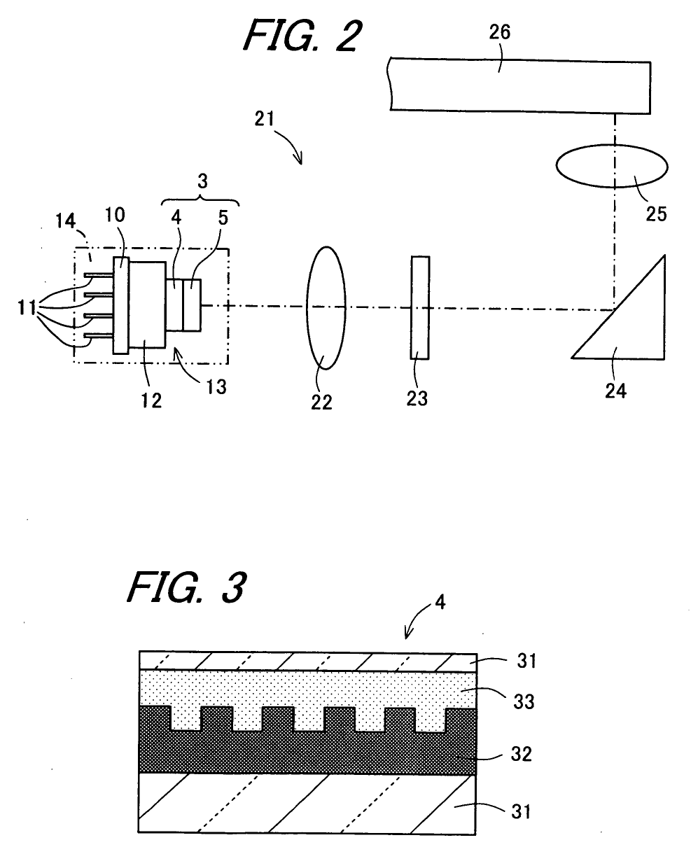

FIG. 2 is a simplified view showing a structure of an optical pickup apparatus 21. The optical pickup apparatus 21 comprises the hologram laser unit 14, a collimation lens 22, a one-quarter wavelength plate 23 which is common to the two wavelengths, an erecting mirror 24 and an objective lens 25. The optical pickup apparatus 21 is an apparatus which executes at least one of processing of optically reading information recorded on an information record surface of an optical disk-shaped recording medium (hereinafter, simply referred to as an ‘optical recording medium’) 26 and processing of optically recording information on to the information record surface of the optical recording medium 26. The optical recording medium 26 is, for example, a CD, a DVD and the like.

The collimation lens 22 makes an incident laser light beam to a parallel light beam. The common-to-two-wavelengths one-quarter wavelength plate 23 (hereinafter, sometimes referred to as a ‘λ/4 plate’) is a polarizing element which causes a phase difference of almost 90 degrees with respect to the two laser light beams of different wavelengths emitted from the first and second semiconductor laser devices 1, 2. When a linearly polarized light beam enters the λ/4 plate 23, the λ/4 plate 23 converts the linearly polarized light beam to a circularly polarized light beam and emits the circularly polarized light beam. When a circularly polarized light beam enters the λ/4 plate 23, the λ/4 plate 23 converts the circularly polarized light beam to a linearly polarized light beam and emits the linearly polarized light beam. The laser light beams emitted from the first and second semiconductor laser devices 1, 2 are the linearly polarized light beams, and these linearly polarized laser light beams are converted to the circularly polarized light beams when entering the λ/4 plate 23. This circularly polarized laser light beams pass through the erecting mirror 24 and the objective lens 25, and are condensed to the information record surface of the optical recording medium 26. The laser light beam reflected on the information record surface passes through the λ/4 plate 23 again, thereby being converted to a linearly polarizing light beam whose polarization direction is orthogonal to that of the linearly polarizing laser light beam before entering the λ/4 plate 23.

The optical pickup apparatus 21 using the first and second polarizing hologram diffraction gratings 7, 8 needs the one-quarter wavelength plate in order to raise the efficiency of light use. Since the two laser light beams of different wavelengths are emitted from the first and second semiconductor laser devices 1, 2 in the embodiment, ideally speaking, a wavelength plate which causes a phase difference of 90 degrees with respect to both the two different wavelengths is desirable, however, such a wavelength plate does not exist at present. Therefore, the common-to-two-wavelengths one-quarter wavelength plate 23 which causes the phase difference of almost 90 degrees with respect to both the wavelengths is disposed, and the amount of deviation from 90 degrees will be handled by allowing as a decrease in signal light amount.

The erecting mirror 24 bends 90 degrees optical paths of the laser light beams emitted from the first and second semiconductor laser devices 1, 2 and transmitted by the λ/4 plate 23, and guides the laser light beams to the objective lens 25. The objective lens 25 condenses the laser light beams bent by the erecting mirror 24 onto the optical recording medium 26.

When driving voltages and driving currents are supplied to the first and second semiconductor laser devices 1, 2 serving as light sources of the optical pickup apparatus 21 via the electrode 11 disposed to the stem 10 of the semiconductor laser apparatus 13, the laser light beams are emitted from the first and second semiconductor laser devices 1, 2. The linearly polarized laser light beams emitted from the first and second semiconductor laser devices 1, 2 enter the three-beam diffraction grating 6. The three-beam diffraction grating 6diffracts the laser light beam, thereby dividing into one main beam and two sub beams. In the following description, there is a case of simply expressing as a ‘light beam’ when referring to at least one of the main beam and the sub beams.

The light beam transmitted by the three-beam diffraction grating 6 passes through the first polarizing hologram diffraction grating 7 and the second polarizing hologram diffraction grating 8, and enters the collimation lens 22. The collimation lens 22 makes the incident light beam to a parallel light beam. The light beam made to a parallel light beam by the collimation lens 22 enters the λ/4 plate 23. The light beam entering the λ/4 plate 23 is converted to a clockwise circularly polarized light beam, and thereafter, bent and guided to the objective lens 25 by the erecting mirror 24. The objective lens 25 condenses the light beam bent by the erecting mirror 24 onto the information record surface of the optical recording medium 26.

The light beam reflected by the information record surface of the optical recording medium 26 is converted to a circularly polarized light beam which is reverse, that is, counterclockwise to the light beam of the outward travel, and follows the same optical path as the light beam of the outward travel. The reflected light beam passes through the λ/4 plate 23 again, thereby being converted from a circularly polarized light beam to a linearly polarized light beam. The light beam emitted from the first semiconductor laser device 1 and reflected on the information record surface of the optical recording medium 26 is diffracted by the second polarizing hologram diffraction grating 8 of the second polarizing hologram substrate 5, and received by the light-receiving device 9. The light beam emitted from the second semiconductor laser device 2 and reflected on the information record surface of the optical recording medium 26 is diffracted by the first polarizing hologram diffraction grating 7 of the first polarizing hologram substrate 4, and received by the light-receiving device 9.

As mentioned above, the first and second polarizing hologram diffraction gratings 7, 8 have a diffraction characteristic such that, when the polarization direction of laser light beams emitted from the first and second semiconductor laser devices 1, 2 and entering themselves is the predetermined first polarization direction, the polarizing hologram diffraction gratings transmit the light beams of the first polarization direction without diffracting. Moreover, the first and second polarizing hologram diffraction gratings 7, 8 have a diffraction characteristic such that the polarizing hologram diffraction gratings diffract a light beam whose polarization direction is converted to the second polarization direction orthogonal to the first polarization direction after the light beam passes through the λ/4 plate 23 twice, to a common region. Therefore, as mentioned above, by placing the light-receiving device 9 or the like in the common region to which the light reflected on the information record surface of the optical recording medium 26 beams are diffracted by the first and second polarizing hologram diffraction gratings 7, 8, it is possible to cause the light-receiving device 9 to receive the light beams diffracted by the first and second polarizing hologram diffraction gratings 7, 8, and easily detect signals necessary for reading information of the optical recording medium 26 such as a DVD and a CD and recording information onto the optical recording medium 26 such as the DVD and the CD.

Further, since the polarizing hologram diffraction gratings are separately disposed for the respective oscillation wavelengths in the embodiment, compared with the case where an optical adjustment such as an optical axis adjustment is performed with respect to the two light beams of different wavelengths in a single polarizing hologram diffraction grating, it is possible to perform the optical adjustment with high accuracy, and it is possible to ease the accuracy of mounting the first and second semiconductor laser devices 1, 2 and the light-receiving device 9. Consequently, an assembly tolerance is eased, and it is possible to increase the yield.

Further, the optical pickup apparatus 21 is provided with the common-to-two-wavelengths one-quarter wavelength plate 23 which functions as an almost one-quarter wavelength plate with respect to light beams of plural different wavelengths. Since this allows shared use of the common-to-two-wavelengths one-quarter wavelength plate 23 for the two light beams of different wavelengths emitted from the first and second semiconductor laser devices 1, 2, it is possible to raise the efficiency of light use with respect to the two light beams of different wavelengths without increasing the number of parts of the optical pickup apparatus 21. Moreover, since it is possible to raise the efficiency of light use with respect to the two light beams of different wavelengths, it is possible to read information of a DVD and a CD and record information onto a DVD and a CD accurately, for example.

FIG. 3 is a cross sectional view showing the first polarizing hologram substrate 4. The first polarizing hologram substrate 4 includes a light transmitting substrate 31, a birefringent layer 32 and an isotropic overcoat layer 33. The light transmitting substrate 31 is made of glass, plastic or the like. The birefringent layer 32 has a diffraction surface having a concave-and-convex periodic shape, and is made of a birefringent material. The birefringent material is a film which represents anisotropy such that a refraction index of light vibrating in a direction parallel to a sheet surface of FIG. 3 is different from a refraction index of light vibrating in a direction perpendicular to the sheet surface. In the embodiment, the birefringent layer 32 is formed by polymerizing a polymerizing liquid crystal monomer with light or heat, for example. It is preferable to select the liquid crystal monomer from among acrylic ester ormethacrylic ester. It is preferable that one or more phenyl groups, specifically, two or three phenyl groups are contained in an alcohol residue constituting ester. Further, one cyclohexyl group may be contained in the alcohol residue constituting ester. Besides, the birefringent layer 32 is identical to the first polarizing hologram diffraction grating 7.

The isotropic overcoat layer 33 is formed by, for example, a spreading method of spreading an amorphous polymer solution which is optically isotropic on the birefringent layer 32 and thereafter volatilizing the solution, or a photopolymerization method of spreading a monomer and thereafter conducting photopolymerization. Especially, the photopolymerization method is preferable because it is simple. The monomer is styrene, a derivative of styrene, acrylic ester, a derivative of acrylic ester, methacrylic ester and a derivative of methacrylic ester. Moreover, an oligomer having polymerizing functional groups on both ends of a molecule, such as acrylic polyether, acrylic urethane and acrylic epoxy, may be used independently or in combination.

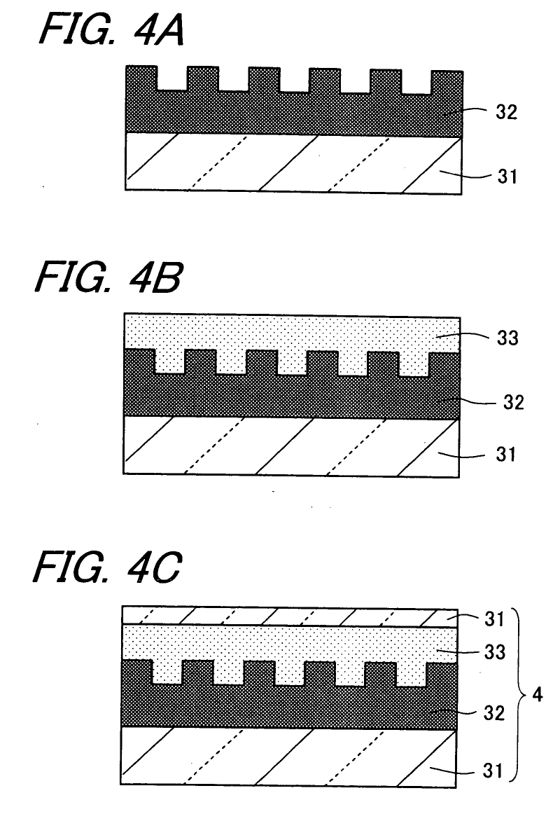

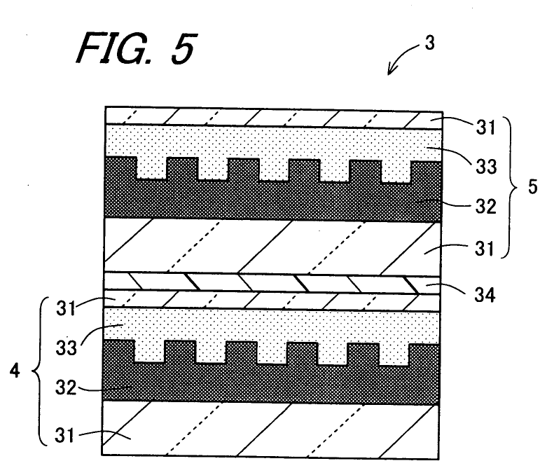

FIGS. 4A to 4C are views for describing the steps in manufacture of the first polarizing hologram substrate 4. FIG. 5 is a cross sectional view showing the hologram coupled member 3. Firstly, as shown in FIG. 4A, the birefringent layer 32 is formed on the light transmitting substrate 31. The birefringent layer 32 is formed by polymerizing the polymerizing liquid crystal monomer with light or heat, for example.

Secondly, as shown in FIG. 4B, the isotropic overcoat layer 33 is formed on the diffraction surface of the birefringent layer 32. The isotropic overcoat layer 33 is formed by, for example, the spreading method of spreading the optically isotropic amorphous polymer solution on the birefringent layer 32 and thereafter volatilizing the solution, or the photopolymerization method of spreading the monomer and thereafter conducting photopolymerization. After the isotropic overcoat layer 33 is formed, the light transmitting substrate 31 is formed on the isotropic overcoat layer 33 as shown in FIG. 4C. By following the above steps, the first polarizing hologram substrate 4 is formed.

Since the second polarizing hologram substrate 5 includes the light transmitting substrate 31, the birefringent layer 32 and the isotropic overcoat layer 33 in the same manner as the first polarizing hologram substrate 4, the second polarizing hologram substrate is formed according to the aforementioned steps in manufacture of the first polarizing hologram substrate 4. The birefringent layer 32 included in the second polarizing hologram substrate 5 is identical to the second polarizing hologram diffraction grating 8.

After the first and second polarizing hologram substrates 4, 5 are formed according to the aforementioned manufacture steps, the first polarizing hologram substrate 4 and the second polarizing hologram substrate 5 are integrated to form the hologram coupled member 3 according to manufacture steps described below.

Firstly, the first polarizing hologram substrate 4 is placed on the surface of the cap 12, and further, the second polarizing hologram substrate 5 is placed on the surface of the first polarizing substrate 4. Then, the second semiconductor laser device 2 is caused to emit a laser light beam whose oscillation wavelength is 780 nm, and an offset adjustment in a focus error signal (hereinafter, sometimes referred to as an ‘FES’) and a tracking error signal (hereinafter, sometimes referred to as a ‘TES’) and an optical adjustment such as an optical axis adjustment are executed.

Secondly, after the first semiconductor laser device 1 is caused to emit the laser light beam whose oscillation wavelength is 650 nm, and the optical adjustment in an FES and a TES is executed, a light transmitting adhesive such as an ultraviolet cure resin is applied and irradiated with ultraviolet rays, whereby the first polarizing hologram substrate 4 is fixed on the cap 12, and the second polarizing hologram substrate 5 is fixed on the first polarizing hologram substrate 4. By following the aforementioned manufacture steps, the hologram coupled member 3 that the first polarizing hologram substrate 4 and the second polarizing hologram substrate 5 are integrated via an optical coupling layer 34 is formed as shown in FIG. 5. Here, the optical coupling layer 34 is formed as a result of cure of the light transmitting adhesive.

As described above, according to the embodiment, by uniformly applying the light transmitting adhesive between the respective surfaces of the first polarizing hologram substrate 4 and the second polarizing hologram substrate 5 facing each other, and adhering the first polarizing hologram substrate 4 and the second polarizing hologram substrate 5, the hologram coupled member 3 is formed. Between the mutually facing surfaces of the first and second polarizing hologram substrates 4, 5 of the hologram coupled member 3, the optically coupling layer 34 formed as a result of cure of the light transmitting adhesive is interposed.

Thus, it is possible to prevent that a gap is left between the first polarizing hologram substrate 4 and the second polarizing hologram substrate 5 and an air layer is interposed as in the related art. Therefore, it is avoided that the refraction index is changed by a change in temperature and humidity as in the related art, and it is possible to transmit a light beam entering the optical coupling layer 34 from the first polarizing hologram substrate 4 to the second polarizing hologram substrate 5. Consequently, compared with in the related art, it is possible to reduce light amount loss caused because light to be condensed on the optical recording medium 26 is not condensed because of refraction of light, and it is possible to increase reliability.

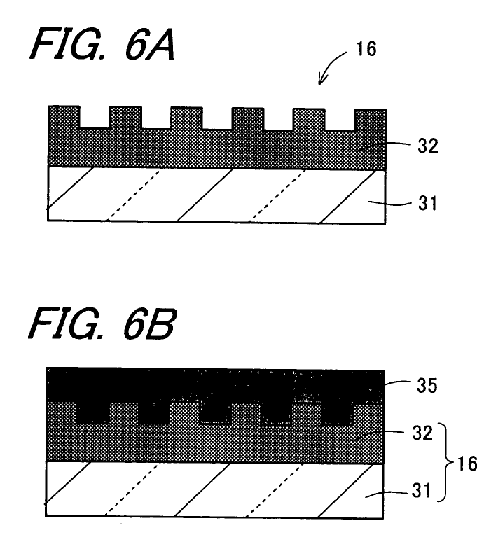

FIGS. 6A and 6B provide views for describing the steps in manufacture of a hologram coupled member 15.

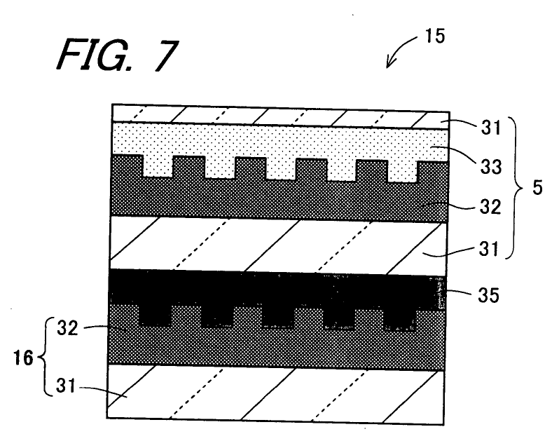

FIG. 7 is a cross sectional view showing the hologram coupled member 15. Firstly, as shown in FIG. 6A, the birefringent layer 32 is formed on the light transmitting substrate 31 by the aforementioned method. After a substrate (hereinafter, referred to as an ‘optical substrate’) 16 in which the birefringent layer 32 is formed on the light transmitting substrate 31 is formed as shown in FIG. 6A, the optical substrate 16 is placed on the surface of the cap 12 shown in FIG. 1. Then, the isotropic overcoat layer 33 is not formed, and instead, a light transmitting adhesive such as an ultraviolet cure resin whose refraction index is almost equal to the refraction index of the isotropic overcoat layer 33 is applied on a diffraction surface of the birefringent layer 32 as shown in FIG. 6B. The second polarizing hologram substrate 5 is placed on the light transmitting adhesive, a laser light beam whose oscillation wavelength is 780 nm and a laser light beam whose oscillation wavelength is 650 nm are emitted, respectively, and an optical adjustment for the respective laser light beams is executed. After execution of the optical adjustment, the second polarizing hologram substrate 5 is fixed on the optical substrate 16 by irradiation of ultraviolet rays. By following the aforementioned manufacture steps, the hologram coupled member 15 that the optical substrate 16 and the second polarizing hologram substrate 5 are integrated via an optical coupling layer 35 is formed as shown in FIG. 7. Here, the optical coupling layer 35 is formed as a result of cure of the light transmitting adhesive having a refraction index almost equal to the refraction index of the isotropic overcoat layer 33.

As described above, according to the embodiment, the light transmitting adhesive whose refraction index is almost equal to that of the isotropic overcoat layer 33 is applied on the diffraction surface of the birefringent layer 32 of the optical substrate 16, and the second polarizing hologram substrate 5 is placed and fixed thereon, whereby the hologram coupled member 15 is formed. Thus, by using the light transmitting adhesive whose refraction index is almost equal to the refraction index of the isotropic overcoat layer 33, it is possible to substitute the optical coupling layer 35 for the isotropic overcoat layer 33.

Therefore, compared with when the isotropic overcoat layer 33 is formed on the diffraction surface of the birefringent layer 32 of the optical substrate 16, the light transmitting substrate 31 is formed thereon and the light transmitting adhesive is formed on the surface of this light transmitting substrate 31, it is possible to omit the steps of forming the isotropic overcoat layer 33 and the light transmitting substrate 31 on the optical substrate 16, with the result that it is possible to reduce the man-hours of manufacture. Reduction of the man-hours of manufacture facilitates the manufacture of the hologram coupled member 15. Moreover, reduction of the man-hours of manufacture enables reduction of the cost for manufacturing the hologram coupled member 15.

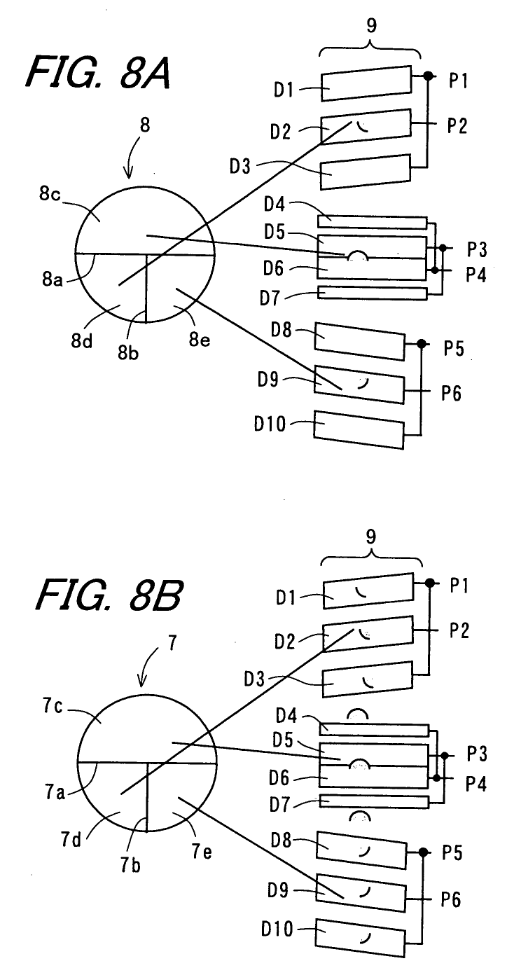

FIGS. 8A and 8B are views showing the first and second polarizing hologram diffraction gratings 7, 8, and the light-receiving device 9 for receiving light beams diffracted by the first and second polarizing hologram diffraction gratings 7, 8. FIG. 8A is a view showing the second polarizing hologram diffraction grating 8, and an example of spot shapes of light beams obtained when reflection light by the optical recording medium 26 of a laser light beam emitted from the first semiconductor laser device 1 is diffracted by the second polarizing hologram diffraction grating 8 and enters the light-receiving device 9. FIG. 8B is a view showing the first polarizing hologram diffraction grating 7, and an example of spot shapes of light beams obtained when reflection light by the optical recording medium 26 of a laser light beam emitted from the second semiconductor laser device 2 is diffracted by the first polarizing hologram diffraction grating 7 and enters the light-receiving device 9.

The second polarizing hologram diffraction grating 8 shown in FIG. 8A diffracts a light beam emitted from the first semiconductor laser device 1 and reflected by the information record surface of a DVD, and guides the diffracted light beam to the light-receiving device 9. The first polarizing hologram diffraction grating 7 shown in FIG. 8B diffracts a light beam emitted from the second semiconductor laser device 2 and reflected by the information record surface of a CD, and guides the diffracted light beam to the light-receiving device 9.

In order to detect an output signal obtained when the spot shapes of the light beams on the light-receiving device 9 change with relative movement of the optical recording medium 26 and the objective lens 25, and keep a space between the optical recording medium 26 and the objective lens 25 fixed, it is necessary to divide the first and second polarizing hologram diffraction gratings 7, 8 into at least two grating regions, respectively. The first and second polarizing hologram diffraction gratings 7, 8 of the embodiment are formed into a circular shape, and have first grating regions 7c, 8c, second grating regions 7d, 8d and third grating regions 7e, 8e as shown in FIGS. 8A and 8B.

Each of the first grating regions 7c, 8c is one of two semicircular regions obtained by dividing each of circular regions with each of first division lines 7a, 8a. Each of the second grating regions 7d, 8d is one of two quarter-circular regions obtained by dividing the other semicircular region of the tow semicircular regions with each of second division lines 7b, 8b which are perpendicular to the first division lines 7a, 8a. Each of the third grating regions 7e, 8e is the other of the two quarter-circular regions.

The light-receiving device 9 has a plurality of light-receiving regions for receiving light beams diffracted by the first grating regions 7c, 8c, the second grating regions 7d, 8d and the third grating regions 7e, 8e of the first and second polarizing hologram diffraction gratings 7, 8, respectively. The light-receiving device 9 of the embodiment has ten light-receiving regions D1 to D10 shown in FIGS. 8A and 8B. The respective light-receiving regions D1 to D10 are selectively used for reading information of a CD and a DVD and detecting an FES, a TES and a reproduction signal (abbreviated as RF).

Further, the light-receiving device 9 is disposed so that longitudinal directions of the respective light-receiving regions D1 to D10 become parallel to directions of diffraction by the first and second polarizing hologram diffraction gratings 7, 8. The respective light-receiving regions D1 to D10 are formed so that lengths in the longitudinal directions become longer than a variation range of incident positions due to variation of the wavelengths of the first and second semiconductor laser devices 1, 2 serving as the light sources. Thus, even when the wavelengths of the first and second semiconductor laser devices 1, 2 vary because of a change in temperature or the like, it is possible to securely receive the light beams and obtain a desirable signal. Moreover, since capacitance increases and response speeds of the respective light-receiving regions D1 to D2 decrease in a case where the lengths in the longitudinal directions of the respective light-receiving regions D1 to D10 are made to be excessively long, the light-receiving device 9 is disposed so as to be formed to have lengths such that the capacitance does not influence on the response speeds.

In the embodiment, a knife-edge method is used for detection of an FES necessary for reading information of a DVD and a CD. Moreover, in the embodiment a Differential Phase Detection (abbreviated as DPD) method is used for detection of a TES necessary for reading information of a DVD, and a Differential Push-pull (abbreviated as DPP) method is used for detection of a TES necessary for reading information of a CD.

In FIGS. 8A and 8B, RFs of a CD and a DVD are detected on the basis of output signals of the light-receiving regions D2, D4, D5, D6, D7, D9. Moreover, a TES of a DVD based on the DPD method is detected on the basis of the output signals of the light-receiving regions D2, D9. As described above, a high response speed is demanded of the light-receiving region for detecting signals containing high-frequency components like an RF and a TES based on the DPD method and requiring rapid reading of a reproduction signal of the optical recording medium 26.

Furthermore, a TES of a CD is detected on the basis of output signals of the light-receiving regions D1, D3, D8, D10, and FESs of a CD and a DVD are detected on the basis of the output signals of the light-receiving regions D4, D5, D6, D7. A high response speed is not demanded of the light-receiving regions D1, D3, D8, D10 for detecting a TES of a CD. Moreover, a high response speed is not demanded of the light-receiving regions D4, D7, because these light-receiving regions are for countervailing a stray light to an FES caused at the time of reading a DVD, which is a two-layer disk, and light does not enter these regions during reproduction of signals.

In FIGS. 8A and 8B, in order to reduce the number of output terminals of the hologram laser unit 14, the light-receiving regions for detecting the same signal may be internally connected. For example, in the embodiment, it is possible to internally connect the light-receiving region D4 and the light-receiving region D6, and connect the light-receiving region D5 and the light-receiving region D7, which are for detecting an FES, respectively. Moreover, it is possible to internally connect the light-receiving region D1 and the light-receiving region D3, and connect the light-receiving region D8 and the light-receiving region D10, which are for detecting a TES based on the DPP method, respectively. In FIGS. 8A and 8B, an output signal at the time of internally connecting the light-receiving region D1 and the light-receiving region D3 is denoted by P1, an output signal at the time of internally connecting the light-receiving region D5 and the light-receiving region D7 is denoted by P3, an output signal at the time of internally connecting the light-receiving region D4 and the light-receiving region D6 is denoted by P4, and an output signal at the time of internally connecting the light-receiving region D8 and the light-receiving region D10 is denoted by P5. Moreover, the output signals of the light-receiving regions D2, D6 are denoted by P2, P6, respectively.

An FES, a TES and an RF based on the signals outputted from the respective light-receiving regions D1 to D10 when light reflected on the information record surface of a DVD is diffracted by the second polarizing hologram diffraction grating 8 and received by the respective light-receiving regions D1 to D10 of the light-receiving device 9 are found by expressions (1) to (3) described below, respectively:

FES=P3−P4 (1)

TES=Phase (P2−P6) (2)

RF=P2+P3+P4+P6 (3)

An FES, a TES and an RF based on the signals outputted from the respective light-receiving regions D1 to D10 when light reflected on the information record surface of a CD is diffracted by the first polarizing hologram diffraction grating 7 and received by the respective light-receiving regions D1 to D10 of the light-receiving device 9 are found by expressions (4) to (6) described below, respectively:

FES=P3−P4 (4)

TES=(P2−P6)−K (P1−P5) (5)

RF=P2+P3+P4+P6 (6)

Here, the coefficient K of the expression (5) is a constant for correcting a light amount ratio of the one main beam and the two sub beams diffracted by the three-beam diffraction grating 6. The coefficient K when the light amount ratio of the main beam : the sub beam : the sub beam is equal to a : b : b (a, b are natural numbers) is given by an expression K=a/(2b).

As described above, the knife-edge method is used for detection of an FES necessary for reading information of a DVD and a CD, the DPD method is used for detection of a TES necessary for reading information of a DVD, and the DPP method is used for detection of a TES necessary for reading information of a CD in the light-receiving device 9 shown in FIGS. 8A and 8B, however, a spot size method may be used for detection of an FES necessary for reading information of a DVD and a CD, the DPP method may be used for detection of a TES necessary for reading information of a DVD, and the DPP method may be used for detection of a TES necessary for reading information of a CD, for example.

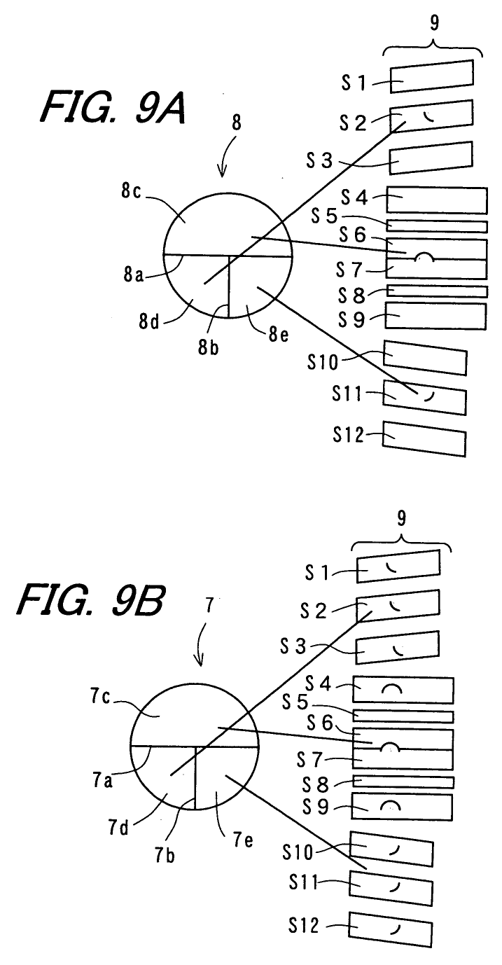

FIGS. 9A and 9B are views showing the first and second polarizing hologram diffraction gratings 7, 8, and the light-receiving device 9 for receiving light beams diffracted by the first and second polarizing hologram diffraction gratings 7, 8. FIG. 9A is a view showing the second polarizing hologram diffraction grating 8, and an example of spot shapes of light beams obtained when reflection light by the optical recording medium 26 of a laser light beam emitted from the first semiconductor laser device 1 is diffracted by the second polarizing hologram diffraction grating 8 and enters the light-receiving device 9. FIG. 9B is a view showing the first polarizing hologram diffraction grating 7, and an example of spot shapes of light beams obtained when reflection light by the optical recording medium 26 of a laser light beam emitted from the second semiconductor laser device 2 is diffracted by the first polarizing hologram diffraction grating 7 and enters the light-receiving device 9.

The second polarizing hologram diffraction grating 8 shown in FIG. 9A diffracts a light beam emitted from the first semiconductor laser device 1 and reflected by the information record surface of a DVD, and guides the diffracted light beam to the light-receiving device 9. The first polarizing hologram diffraction grating 7 shown in FIG. 9B diffracts a light beam emitted from the second semiconductor laser device 2 and reflected by the information record surface of a CD, and guides the diffracted light beam to the light-receiving device 9. Since the first and second polarizing hologram diffraction gratings 7, 8 shown in FIGS. 9A and 9B have the same shapes and functions as the first and second polarizing hologram diffraction gratings 7, 8 shown in FIGS. 8A and 8B, corresponding portions will be denoted by the same reference numerals to omit descriptions thereof.

The light-receiving device 9 shown in FIGS. 9A and 9B has a plurality of light-receiving regions for receiving light beams diffracted by the first grating regions 7c, 8c, the second grating regions 7d, 8d and the third grating regions 7e, 8e of the first and second polarizing hologram diffraction gratings 7, 8, respectively. As shown in FIGS. 9A and 9B, the light-receiving device 9 of the embodiment has twelve light-receiving regions S1 to S12. The respective light-receiving regions S1 to S12 are selectively used for reading information of a CD and a DVD and detecting an FES, a TES and an RF.

In FIGS. 9A and 9B, the knife-edge method is used for detection of an FES necessary for reading information of a DVD and a CD. Moreover, the DPD method is used for detection of a TES necessary for reading information of a DVD, and a three-beam method is used for detection of a TES necessary for reading information of a CD.

In FIGS. 9A and 9B, RFs of a CD and a DVD are detected on the basis of output signals of the light-receiving regions S2, S5, S6, S7, S8, S11. Further, a TES of a DVD based on the DPD method is detected on the basis of the output signals of the light-receiving regions S2, S11. Furthermore, a TES of a CD is detected on the basis of output signals of the light-receiving regions S1, S3, S4, S9, S10, S12. A high response speed is not demanded of the light-receiving regions S5, S8, because these light-receiving regions are for countervailing a stray light to an FES caused at the time of reading a DVD, which is a two-layer disk, and light does not enter these regions during reproduction of signals.

Although a state of internally connecting the light-receiving regions for detecting the same signal is not shown in FIGS. 9A and 9B, the light-receiving regions may be internally connected in the same manner as in FIG. 8A and 8B, in order to reduce the number of the output terminals of the hologram laser unit 14. For example, in the embodiment, it is possible to internally connect the light-receiving region S5 and the light-receiving region S7, and connect the light-receiving region S6 and the light-receiving region S8, which are for detecting an FES, respectively. Moreover, it is possible to internally connect the light-receiving region S1, the light-receiving region S4 and the light-receiving region S10, and connect the light-receiving region S3, the light-receiving region S9 and the light-receiving region S12, which are for detecting a TES based on the three-beam method, respectively.

An FES, aTES and an RF based on the signals outputted from the respective light-receiving regions S1 to S12 when light reflected on the information record surface of a DVD is diffracted by the second polarizing hologram diffraction grating 8 and received by the respective light-receiving regions S1 to S12 of the light-receiving device 9 are found by expressions (7) to (9) described below, respectively:

FES=(S5+S7)−(S6+S8) (7)

TES=S2−S11 (8)

RF=S2+(S5+S7)+(S6+S8)+S11 (9)

An FES, a TES and an RFbased on the signals outputted from the respective light-receiving regions S1 to S12 when light reflected on the information record surface of a CD is diffracted by the first polarizing hologram diffraction grating 7 and received by the respective light-receiving regions S1 to S12 of the light-receiving device 9 are found by expressions (10) to (12) described below, respectively:

FES=(S5+S7)−(S6+S8) (10)

TES=(S1+S4+S10)−(S3+S9+S12) (11)

RF=S2+(S5+S7)+(S6+S8)+S11 (12)

As described above, the knife-edge method is used for detection of an FES necessary for reading information of a DVD and a CD, the DPD method is used for detection of a TES necessary for reading information of a DVD, and the three-beam method is used for detection of a TES necessary for reading information of a CD in the light-receiving device 9 shown in FIGS. 9A and 9B, however, the spot size method may be used for detection of an FES necessary for reading information of a DVD and a CD, and the DPP method may be used for detection of a TES necessary for reading information of a DVD and a CD, for example.

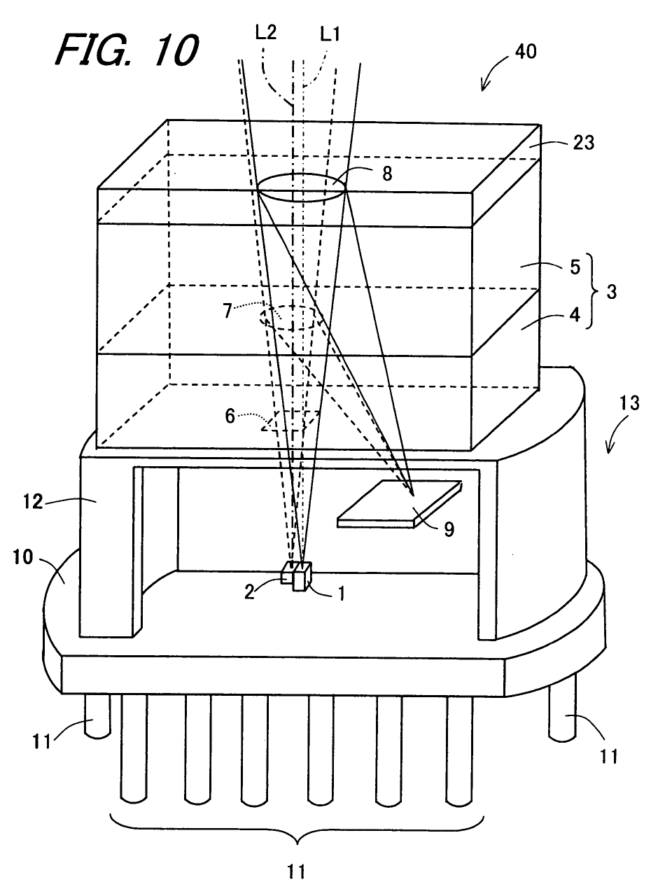

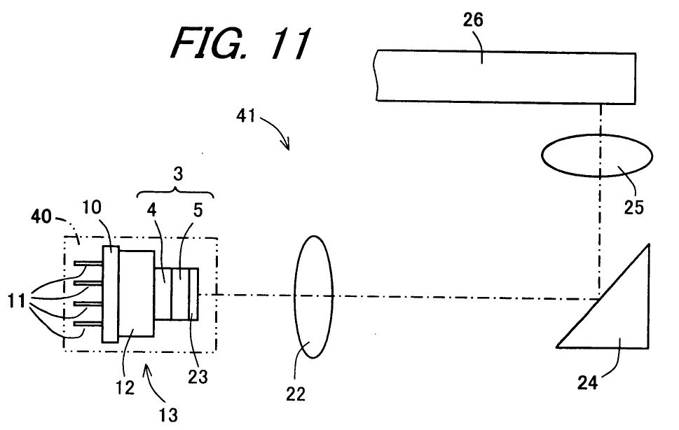

FIG. 10 is a simplified perspective view showing a structure of a hologram laser unit 40 comprising the hologram coupled member 3, which is another embodiment of the invention. FIG. 11 is a simplified view showing a structure of the optical pickup apparatus 41. In FIG. 10, a cap 12 described later is partially cut away to show. Since the hologram laser unit 40 is similar to the hologram laser unit 14 in the optical pickup apparatus 21 described above, and the hologram laser unit 40 has the same structure and function as the hologram laser unit 14 except that the λ/4 plate 23 is integrally formed on the hologram coupled member 3, corresponding portions will be denoted by the same reference numerals, and descriptions of the same structure and function as those of the hologram laser unit 14 will be omitted. The optical pickup apparatus 41 is an apparatus which executes at least one of a process of optically reading information recorded on the information recording surface of the optical recording medium 26 and a process of optically recording information on the information recording surface of the optical recording medium 26.

Although the λ/4 plate 23 is placed between the collimation lens 22 and the erecting mirror 24 in the optical pickup apparatus 21 shown in FIG. 2, the λ/4 plate 23 is integrated with the hologram coupled member 3 of the hologram laser unit 40 in the optical pickup apparatus 41 as shown in FIG. 11. In concrete, the λ/4 plate 23 is integrally mounted and structured on one surface portion in the thickness direction of the second polarizing hologram substrate 5 of the hologram coupled member 3.

According to the embodiment as described above, by integrating the λ/4 plate 23 and the hologram coupled member 3 to structure the hologram laser unit 40, the number of optical components and the number of steps in assembly at the time of manufacture are reduced, and an operation of an optical adjustment such as an optical axis adjustment is simplified. Moreover, in the case of using the hologram laser unit 40 that the number of optical components is reduced, in the optical pickup apparatus 41, it is possible to make the length of an optical path between the hologram laser unit 40 and the erecting mirror 24 to be shorter than in the optical pickup apparatus 21, with the result that it is possible to reduce the size of the optical pickup apparatus 41, and it is possible to decrease the cost of manufacture of the optical pickup apparatus 41.

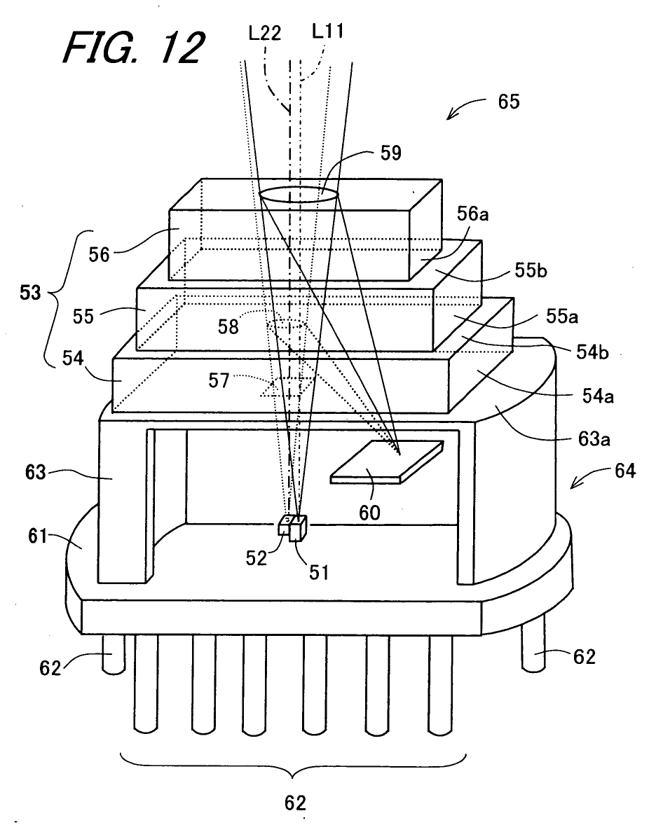

FIG. 12 is a simplified perspective view showing a structure of a hologram laser unit 65 including a hologram coupled member 53, which is still another embodiment of the invention. In FIG. 12, a cap 63 described later is partially cut away to show. The hologram laser unit 65 comprises the hologram coupled member 53 and a semiconductor laser apparatus 64. The semiconductor laser apparatus 64 includes a first semiconductor laser device 51, a second semiconductor laser device 52, a light receiving device 60, a stem 61, an electrode 62 and the cap 63. The hologram coupled member 53 includes a nonpolarizing hologram substrate 54 serving as the first substrate, an optical coupling layer 55, and a polarizing hologram substrate 56 serving as the second substrate. The nonpolarizing hologram substrate 54 serving as the first substrate includes a beam splitting diffraction grating 57 and a nonpolarizing hologram diffraction grating 58 which serves as the first optical element, and the polarizing hologram substrate 56 serving as the second substrate includes a polarizing hologram diffraction grating 59 serving as the second optical element.

The optical coupling layer 55 is interposed and laminated between the respective surfaces of the nonpolarizing hologram substrate 54 and the polarizing hologram substrate 56, the surfaces facing each other. The nonpolarizing hologram substrate 54 and the optical coupling layer 55 of the embodiment are made of a light transmitting solid material. The nonpolarizing hologram substrate 54 and the optical coupling layer 55 are realized by silica glass, soda glass, borosilicate glass, acrylic resin or the like.

The first semiconductor laser device 51 emits a laser light beam of an infrared wavelength whose oscillation wavelength is, for example, 650 nm. The first semiconductor laser device 51 is used for reading information recorded on an information recording surface of a DVD (Digital Versatile Disk), for example. The second semiconductor laser device 52 emits a laser light beam of an infrared wavelength whose oscillation wavelength is, for example, 780 nm. The second semiconductor laser device 52 is used for reading information recorded on an information recording surface of a CD (Compact Disk) and recording information on an information recording surface of a CD, for example. The first and second semiconductor laser devices 51, 52 are placed adjacent to each other in a direction perpendicular to an optical axis L11 of the laser light beam emitted from the first semiconductor laser device 51 and an optical axis L22 of the laser light beam emitted from the second semiconductor laser device 52, and mounted on one surface portion in a thickness direction of the stem 61 formed like a plate. The optical axis L11 of the laser light beam emitted from the first semiconductor laser device 51 and the optical axis L22 of the laser light beam emitted from the second semiconductor laser device 52 are parallel to each other.

The beam splitting diffraction grating 57 diffracts a laser light beam entering itself, thereby splitting the laser light beam into one main beam and two sub beams. The nonpolarizing hologram diffraction grating 58 diffracts incident light. Describing in detail, the diffraction efficiency of the nonpolarizing hologram diffraction grating 58 is almost constant regardless of a polarization direction of the incident light. The diffraction efficiency of the polarizing hologram diffraction grating 59 varies depending on a polarization direction of the incident light. The polarizing hologram diffraction grating 59 has a diffraction characteristic such that it makes the diffraction efficiency to be relatively large for a light beam of a predetermined first polarization direction and makes the diffraction efficiency to be small for a light beam of a second polarization direction orthogonal to the first polarization direction.

In the embodiment, a light beam of the first polarization direction emitted from the first semiconductor laser device 51 and entering the polarizing hologram diffraction grating 59 is transmitted without being diffracted. After passing through a five-quarters wavelength plate 73 described later and is condensed to the optical recording medium, a light beam transmitted by the polarizing hologram diffraction gratings 59 is reflected by the optical recording medium and passes through the five-quarters wavelength plate 73 again, whereby the polarization direction is converted to the second polarization direction orthogonal to the first polarization direction, and the light beam enters the polarizing hologram diffraction grating 59. A light beam whose polarization direction is converted from the first polarization direction to the second polarization direction is diffracted in a predetermined diffraction direction by the polarizing hologram diffraction grating 59.

Further, in the embodiment, a light beam of the first polarization direction emitted from the second semiconductor laser device 52 and entering the polarizing hologram diffraction grating 59 is transmitted without being diffracted. Even if a light beam transmitted by the polarizing hologram diffraction gratings 59 passes through the five-quarters wavelength plate 73 described later to be condensed to the optical recording medium, and thereafter, the light beam is reflected by the optical recording medium to pass through the five-quarters wavelength plate 73 again, the polarization direction is not converted, and the light beam enters the polarizing hologram diffraction grating 59 as the polarization direction remains the first polarization direction. A light beam of the first polarization direction entering the polarizing hologram diffraction grating 59 is transmitted by the polarizing hologram diffraction grating 59, and enters the nonpolarizing hologram diffraction grating 58. The light beam entering the nonpolarizing hologram diffraction grating 58 is diffracted in a predetermined diffraction direction by the nonpolarizing hologram diffraction grating 58.

The nonpolarizing hologram diffraction grating 58 and the polarizing hologram diffraction grating 59 are optimized for, of the two light beams of different wavelengths emitted from the first and second semiconductor laser devices 51, 52, only one of the light beams or both the light beams. The polarizing hologram diffraction grating 59 optimized for only one of the light beams sometimes causes light amount loss when transmitting the other light beam. In this case, it is good to optimize the polarizing hologram diffraction grating 59 for a light beam of a wavelength used for an optical recording medium which needs writing. Consequently, it is possible to minimize the light amount loss of the laser light beam required for writing.

The light receiving device 60 is realized by, for example, a photodiode, and converts incident light to electric signals. The cap 63 is a sealing member for sealing the first and second semiconductor laser devices 51, 52 and the light receiving device 60 in order to avoid that the first and second semiconductor laser devices 51, 52 and the light receiving device 60 physically come into contact with the outside, and is mounted on one surface portion in the thickness direction of the stem 61 formed like a plate. Consequently, the first and second semiconductor laser devices 51, 52 and the light receiving device 60 are sealed hermetically by the stem 61 and the cap 63. The electrode 62 is disposed so as to protrude from the other surface portion in the thickness direction of the stem 61 toward the other direction in the thickness direction of the stem 61, and electrically connected to the first and second semiconductor laser devices 51, 52.

The nonpolarizing hologram substrate 54 formed into a rectangular parallelepiped is mounted on the semiconductor laser apparatus 64. Describing in detail, the nonpolarizing hologram substrate 54 is mounted on one surface portion of the cap 63, the surface portion being perpendicular to the optical axes L11, L22. The beam splitting diffraction grating 57 is formed on the other surface portion in the thickness direction of the nonpolarizing hologram substrate 54, and the nonpolarizing hologram diffraction grating 58 is formed on a surface portion opposite to the surface portion where the beam splitting diffraction grating 57 is formed, that is, on one surface portion in the thickness direction of the nonpolarizing hologram substrate 54. The optical coupling layer 55 formed into a rectangular parallelepiped is mounted on one surface portion in the thickness direction of the nonpolarizing hologram substrate 54. The polarizing hologram substrate 56 formed into a rectangular parallelepiped is mounted on one surface portion in the thickness direction of the optical coupling layer 55. The polarizing hologram diffraction grating 59 is formed on a surface portion of the polarizing hologram substrate 56, the surface portion being opposite to the surface joined to the optical coupling layer 55, that is, on one surface portion in the thickness direction of the polarizing hologram substrate 56. In the embodiment, the beam splitting diffraction grating 57 and the nonpolarizing hologram diffraction grating 58 formed on the nonpolarizing hologram substrate 54, and the polarizing hologram diffraction grating 59 formed on the polarizing hologram substrate 56 are formed by etching, injection molding or the like.

As described above, according to the embodiment, the optical coupling layer 55 is made of a light transmitting solid material such as silica glass and acrylic resin. Consequently, it is possible to make scattering of light and attenuation of light to be as little as possible, and transmit light guided from the nonpolarizing hologram substrate 54 and guide the light to the polarizing hologram substrate 56. Moreover, by forming the optical coupling layer 55 by a solid material, it is possible to prevent deformation and distortion of optical components such as the nonpolarizing hologram substrate 54 and the polarizing hologram substrate 56, and avoid deviation of the optical axes L11, L22 of the laser light beams emitted from the first and second semiconductor laser devices 51, 52.

Further, according to the embodiment, by forming the nonpolarizing hologram diffraction grating 58 on the nonpolarizing hologram substrate 54, and forming the polarizing hologram diffraction grating 59 on the polarizing hologram substrate 56, it is possible to diffract and transmit only incident light of a specified polarization direction, in a specified direction on the basis of a polarization direction of the incident light. Therefore, it is possible to prevent that the efficiency of the use of light decreases because of diffraction of the incident light in an undesired direction as in the related art.

Still further, according to the embodiment, on a surface portion of the nonpolarizing hologram substrate 54, the surface portion being opposite to a surface portion on which the nonpolarizing hologram diffraction grating 58 is formed, the beam splitting diffraction grating 57 is formed. By thus forming the beam splitting diffraction grating 57 on the nonpolarizing hologram substrate 54 where the nonpolarizing hologram diffraction grating 58 is formed, it is possible to reduce the number of optical components as compared with the case where the beam splitting diffraction grating 57 is disposed singly. Moreover, for example, in the case of using the hologram coupled member 65 that the number of optical components is reduced, in an optical pickup apparatus, it is possible to reduce the size and weight of the optical pickup apparatus, and it is possible to decrease the cost of manufacture of the optical pickup apparatus.

Still further, according to the embodiment, the beam splitting diffraction grating 57 splits incident light into one main beam and two sub beams. By thus causing the beam splitting diffraction grating 57 to split incident light into one main beam and two sub beams, it is possible to correct deviation of light condensed to the optical recording medium from the center of a track on the basis of, for example, signals outputted when the main beam and the sub beams are reflected by the optical recording medium and received by the light receiving device, and obtain a tracking error signal used for causing light to accurately follow the track.

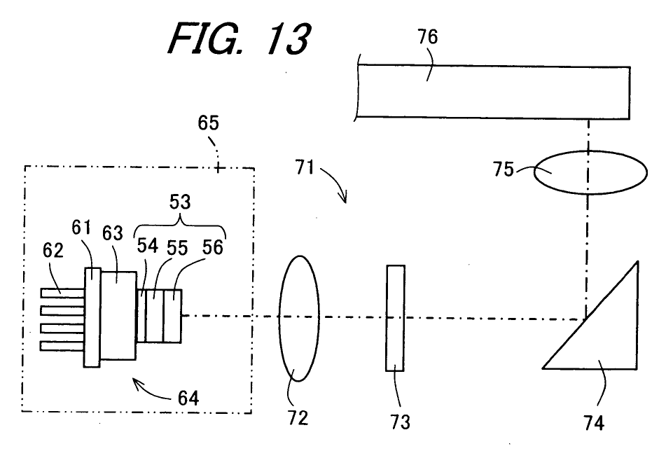

FIG. 13 is a simplified view showing a structure of an optical pickup apparatus 71. The optical pickup apparatus 71 comprises the hologram laser unit 65, a collimation lens 72, the five-quarters wavelength plate 73, an erecting mirror 74 and an objective lens 75. The optical pickup apparatus 71 is an apparatus which executes at least one of a process of optically reading information recorded on an information recording surface of an optical disk-shaped recording medium (hereinafter, simply referred to as an ‘optical recording medium’) 76 and a process of optically recording information on the information recording surface of the optical recording medium 76. The optical recording medium 76 is a CD, a DVD or the like.

The collimation lens 72 makes an entering laser light beam to be a parallel light beam. The five-quarters wavelength plate 73 (hereinafter, sometimes referred to as a ‘5λ/4 plate’) is a polarizing element which gives different phase differences to respective laser light beams of two different wavelength bands emitted from the first and second semiconductor laser devices 51, 52, respectively, and is realized by a light transmitting phase difference film. The 5λ/4 plate 73 is formed by polycarbonate resin, polyvinyl alcohol resin or the like. The 5λ/4 plate 73 is placed on a light path between the polarizing hologram substrate 56 provided with the polarizing hologram diffraction grating 59 serving as the second optical element and the objective lens 75 described later.

The optical pickup apparatus 71 using the nonpolarizing hologram diffraction grating 58 and the polarizing hologram diffraction grating 59 makes it possible to increase the efficiency of the use of light, by using a polarization characteristic such that different phase differences are given to the respective laser light beams of different wavelengths.

The 5λ/4 plate 73 is a polarizing element which gives a phase difference of almost 90 degrees to a laser light beam emitted from the first semiconductor laser device 51, that is, a polarizing element which functions as a one-quarter wavelength plate for the laser light beam emitted from the first semiconductor laser device 51. When a linearly polarized light beam from the first semiconductor laser device 51 enters the 5λ/4 plate 73, the 5λ/4 plate 73 converts the linearly polarized light beam to a circularly polarized light beam and emits the circularly polarized light beam. When a circularly polarized light beam enters the 5λ/4 plate 73, the 5λ/4 plate 73 converts the circularly polarized light beam to a linearly polarized light beam and emits the linearly polarized light beam. The laser light beam emitted from the first semiconductor laser device 51 is a linearly polarized light beam, and when the linearly polarized laser light beam enters the 5λ/4 plate 73, it is converted to a circularly polarized laser light beam. The circularly polarized laser light beam passes through the erecting mirror 74 and the objective lens 75, and is condensed to the information recording surface of the optical recording medium 76. A laser light beam reflected by the information recording surface of the optical recording medium 76 passes through the 5λ/4 plate 73 again, thereby being converted into a linearly polarized light beam whose polarization direction crosses at right angles with that of the linearly polarized laser light beam before entering the 5λ/4 plate 73.

Further, the 5λ/4 plate 73 is a polarizing element which gives a phase difference of almost 360 degrees to a laser light beam emitted from the second semiconductor laser device 52, that is, a polarizing element which functions as a wavelength plate for the laser light beam emitted from the second semiconductor laser device 52. When a linearly polarized light beam from the second semiconductor laser device 52 enters the 5λ/4 plate 73, the 5λ/4 plate 73 transmits the linearly polarized light beam as it is. The laser light beam emitted from the second semiconductor laser device 52 is a linearly polarized light beam, and even if entering the 5λ/4 plate 73, the linearly polarized laser light beam is transmitted as it is. The linearly polarized laser light beam transmitted by the 5λ/4 plate 73 passes through the erecting mirror 74 and the objective lens 75, and is condensed to the information recording surface of the optical recording medium 76. Even if a laser light beam reflected by the information recording surface of the optical recording medium 76 passes through the 5λ/4 plate 73 again, it remains a linearly polarized light beam whose polarization direction is the same direction as that of the linearly polarized laser light beam before entering the 5λ/4 plate 73.

The erecting mirror 74 bends 90 degrees optical paths of the laser light beams emitted from the first and second semiconductor laser devices 51, 52 and transmitted by the 5λ/4 plate 73, and guides the laser light beams to the objective lens 75. The objective lens 75 is condensing means for condensing the laser light beams bent by the erecting mirror 74 to the optical recording medium 76.

When a driving voltage and a driving current are supplied to the first and second semiconductor laser devices 51, 52 serving as light sources of the optical pickup apparatus 71 via the electrode 62 disposed to the stem 61 of the semiconductor laser apparatus 64, laser light beams are emitted from the first and second semiconductor laser devices 51, 52. The linearly polarized laser light beams emitted from the first and second semiconductor laser devices 51, 52 enter the beam splitting diffraction grating 57 formed on the nonpolarizing hologram substrate 54.

Here, in the case of using a Differential Phase Detection (abbreviated as DPD) method in order to detect a tracking error signal (hereinafter, sometimes referred to as an ‘TES’) necessary for reading information of a DVD, and using a three-beam method or a Differential Push-pull (abbreviated as DPP) method in order to detect a TES necessary for reading information of a CD, the beam splitting diffraction grating 57 having a predetermined diffraction characteristic is required. The predetermined diffraction characteristic of the beam splitting diffraction grating 57 is a diffraction characteristic such that the grating diffracts the laser light beam emitted from the second semiconductor laser device 52 and thereby splits the laser light beam into a transmission light beam as a main beam and primary diffraction light beams as two sub beams and hardly diffracts the laser light beam emitted from the first semiconductor laser device 51.

In order to form the beam splitting diffraction grating 57 having the aforementioned diffraction characteristic, it is necessary to properly set the length of a diffraction grating groove disposed to the beam splitting diffraction grating 57 to make unnecessary light generated by diffraction to be as small as possible. For example, in the case of setting the length of the diffraction grating groove disposed to the beam splitting diffraction grating 57 to 1.4 μm, for the laser light beam emitted from the second semiconductor laser device 52, the transmissivity of the main beam, that is, the transmissivity of the transmission light beam is 72%, and the diffraction efficiency of the sub beam, that is, the diffraction efficiency of the primary diffraction light beam is 12%, with the result that a proper light amount ratio of three beams can be obtained. Moreover, in the case of setting the length of the diffraction grating groove to 1.4 μm, the diffraction efficiency for the laser light beam emitted from the first semiconductor laser device 51 is nearly zero, with the result that it is possible to transmit the laser light beam emitted from the first semiconductor laser device 51 while hardly diffracting. In the following description, when mentioning at least one of the main beam and the two sub beams, there is a case of simply referring to as ‘light.’

In the case of using the Differential Push-pull (abbreviated as DPP) method to detect a TES which is necessary for reading information of a CD and a DVD and recording information on a CD and a DVD, the beam splitting diffraction grating 57 for splitting incident light into one main beam and two sub beams and giving a phase difference of 180 degrees to one of the sub beams so that the amplitude of a difference signal of the two sub beams, that is, a push-pull signal of the sub beam becomes nearly zero is used. In order that a phase difference of 180 degrees is given to one of the sub beams, the beam splitting diffraction grating 57 is designed actually in a manner that part of a periodic structure of the diffraction grating groove of the beam splitting diffraction grating 57 is shifted by one half pitch in a track direction which is orthogonal to a direction corresponding to a radial direction of the optical recording medium 76.

As described above, according to the embodiment, by using the beam splitting diffraction grating for giving a phase difference of 180 degrees to one of the sub beams so that the amplitude of a difference signal of the two sub beams, actually, a push-pull signal of the sub beams becomes nearly zero, even in the case of using optical recording mediums of different track pitches, it is possible to, for example, countervail an offset caused by a shift of the objective lens and a tilt of a disk, without lowering the efficiency of the use of light, when detecting a tracking error signal. Consequently, it is possible to cause the objective lens to follow the eccentricity of the optical recording medium, and execute stable tracking servo such that the one main beam and the two sub beams split by the beam splitting diffraction grating 57 trace on aimed tracks at all times. Moreover, by using the beam splitting diffraction grating 57 for giving a phase difference of 180 degrees to one of the sub beams so that the amplitude of a difference signal of the two sub beams becomes nearly zero, the need for rotating and adjusting the diffraction grating to adjust the positions of the sub beams is eliminated, and it is possible to facilitate an assembly adjustment of the optical pickup apparatus 71.

Light beams emitted from the first and second semiconductor laser devices 51, 52 and passing through the beam splitting diffraction grating 57 are transmitted by the nonpolarizing hologram substrate 54 provided with the nonpolarizing hologram diffraction grating 58, the optical coupling layer 55, and the polarizing hologram substrate 56 provided with the polarizing hologram diffraction grating 59, and enter the collimation lens 72. The collimation lens 72 makes entering light beams to be parallel light beams. Light beams made to be parallel light beams by the collimation lens 72 enter the 5λ/4 plate 73.

When the light beam emitted from the first semiconductor laser device 51, which is a polarizing light beam, enters the 5λ/4 plate 73, it is converted to a circularly polarized light beam which is clockwise, and thereafter, bent and guided to the objective lens 75 by the erecting mirror 74. The objective lens 75 condenses the light beam bent by the erecting mirror 74 onto the information record surface of the optical recording medium 76. A light beam reflected by the information record surface of the optical recording medium 76 is converted to a circularly polarized light beam, which is reverse, that is, counterclockwise to the light beam traveling to the optical recording medium, and follows the same optical path as in travel to the optical recording medium. The reflected light beam passes through the 5λ/4 plate 73 again, thereby being converted from a circularly polarized light beam to a linearly polarized light beam. The light beam emitted from the first semiconductor laser device 51 and reflected on the information record surface of the optical recording medium 76 is diffracted by the polarizing hologram diffraction grating 59 of the polarizing hologram substrate 56, and received by the light receiving device 60.

Even if the linearly polarized light beam emitted from the second semiconductor laser device 52 enters the 5λ/4 plate 73, it is transmitted as a linearly polarized light beam, and bent and guided to the objective lens 75 by the erecting mirror 74. The objective lens 75 condenses the light beam bent by the erecting mirror 74, to the information recording surface of the optical recording medium 76. Even if a light beam reflected by the information recording surface of the optical recording medium 76 follows the same optical path as in travel to the optical recording medium, and passes through the 5λ/4 plate 73 again, it remains a linearly polarized light beam whose polarization direction is the same as that of the light beam emitted from the second semiconductor laser device 52. The light beam emitted from the second semiconductor laser device 52 and reflected by the information recording surface of the optical recording medium 76 is hardly diffracted by the polarizing hologram diffraction grating 59 formed on the polarizing hologram substrate 56, because the light beam is a linearly polarized light beam. Consequently, it is possible to decrease occurrence of unnecessary light as much as possible. Moreover, the light beam emitted from the second semiconductor laser device 52 and reflected by the information recording surface of the optical recording medium 76 is transmitted by the polarizing hologram substrate 56 and the optical coupling layer 55, diffracted by the nonpolarizing hologram diffraction grating 58 formed on the nonpolarizing hologram substrate 54, and received by the light receiving device 60.

As described above, according to the embodiment, the nonpolarizing hologram diffraction grating 58 and the polarizing hologram diffraction grating 59 have a diffraction characteristic such that they transmit laser light beams emitted from the first and second semiconductor laser devices 51, 52 and entering themselves and diffract reflection light beams of the transmitted light beams by the optical recording medium 76 to a common region of the light receiving device 60. Therefore, it is possible to cause the light receiving device 60 to receive light beams diffracted by the nonpolarizing hologram diffraction grating 58 and the polarizing hologram diffraction grating 59, and easily detect signals necessary for reading information of a CD and a DVD and recording information on a CD and a DVD, for example.

Further, according to the embodiment, the hologram diffraction gratings are separately disposed for the respective oscillation wavelengths. In specific, the nonpolarizing hologram diffraction grating 58 and the polarizing hologram diffraction grating 59 are disposed. Therefore, as compared with when an optical adjustment such as an optical axis adjustment is executed for two light beams of different wavelength bands by one hologram diffraction grating, it is possible to execute the optical adjustment with high accuracy, and it is possible to ease the accuracy of mounting the first and second semiconductor laser devices 51, 52 and the light receiving device 60. Consequently, the tolerance of assembly is eased, and a yield can be increased.

Still further, according to the embodiment, by placing the 5λ/4 plate 73 on an optical path between the polarizing hologram substrate 56 where the polarizing hologram diffraction grating 59 is formed and the objective lens 75, it is possible to give different phase differences to respective light beams of first and second wavelength bands emitted from the first and second semiconductor laser devices 51, 52 and execute an adjustment in a polarization direction of the respective light beams. Moreover, since it is possible to use the 5λ/4 plate 73 in common for the light beams of the first and second wavelength bands, it is possible, without increasing the number of optical components of the optical pickup apparatus 71, to prevent occurrence of unnecessary light resulting from diffraction of light and the like as much as possible and prevent decrease of the efficiency of the use of light. Consequently, it is possible to accurately read information of a CD and a DVD and record information on a CD and a DVD, for example.

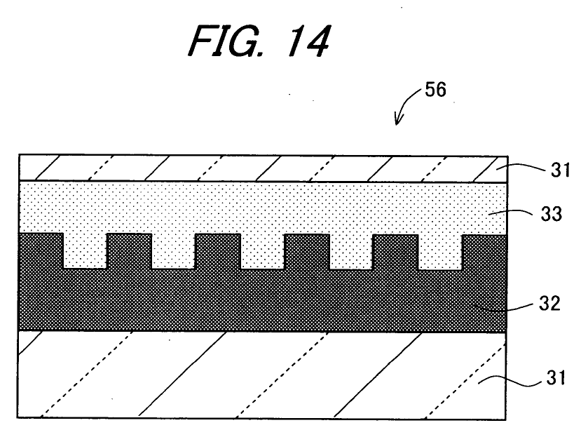

FIG. 14 is a cross sectional view showing the polarizing hologram substrate 56. The polarizing hologram substrate 56 comprises the light transmitting substrate 31, the birefringent layer 32 and the isotropic overcoat layer 33. Since the polarizing hologram substrate 56 has the same structure as the first polarizing hologram substrate 4 described in the aforementioned embodiment, corresponding portions will be denoted by the same reference numerals and a description thereof will be omitted. Moreover, since the steps in manufacture of the polarizing hologram substrate 56 is the same as the steps in manufacture of the first polarizing hologram substrate 4 described in the aforementioned embodiment, a description thereof will be omitted.

After formation of the nonpolarizing hologram substrate 54 and the polarizing hologram substrate 56, according to the steps in assembly described later, the nonpolarizing hologram substrate 54, the optical coupling layer 55 and the polarizing hologram substrate 56 are formed into one body, and the hologram coupled member 53 is formed. Firstly, on one surface portion in the thickness direction of the nonpolarizing hologram substrate 54, the optical coupling layer 55 is placed and fixed by application of a light transmitting adhesive such as an ultraviolet cure resin and irradiation of ultraviolet rays. Then, on one surface portion of the cap 63, which is perpendicular to the optical axes L11, L22, an optical component obtained by placing and fixing the optical coupling layer 55 on the one surface portion in the thickness direction of the nonpolarizing hologram substrate 54 is placed. Secondly, on one surface portion in the thickness direction of the optical coupling layer 55, the polarizing hologram substrate 56 is placed. Then, a laser light beam whose oscillation wavelength is 780 nm is emitted from the second semiconductor laser device 52, and an offset adjustment of a focus error signal (hereinafter, sometimes referred to as an ‘FES’) and a tracking error signal (hereinafter, sometimes referred to as a ‘TES’) and an optical adjustment such as an optical axis adjustment are executed.

Subsequently, a laser light beam whose oscillation wavelength is 650 nm is emitted from the first semiconductor laser device 51, and an offset adjustment of an FES and a TES and an optical adjustment such as an optical axis adjustment are executed. After execution of the optical adjustment for the laser light beams emitted from the first and second semiconductor laser devices 51, 52, respectively, by application of a light transmitting adhesive such as an ultraviolet cure resin and irradiation of ultraviolet rays, the nonpolarizing hologram substrate 54 and the optical coupling layer 55 are fixed, and the optical coupling layer 55 and the polarizing hologram substrate 56 are fixed. Thus, the hologram coupled member 53 such that the nonpolarizing hologram substrate 54 and the polarizing hologram substrate 56 are integrated via the optical coupling layer 55 is formed.

In the embodiment, the nonpolarizing hologram substrate 54 is joined to one surface in the thickness direction of the cap 63 of the semiconductor laser apparatus 64 in a state where a peripheral region thereof is exposed, the optical coupling layer 55 is joined to one surface in the thickness direction of the nonpolarizing hologram substrate 54 in a state where a peripheral region thereof is exposed, and the polarizing hologram substrate 56 is joined to one surface in the thickness direction of the optical coupling layer 55 in a state where a peripheral region thereof is exposed.

Here, a first surface 63a of the semiconductor laser apparatus 64 facing the nonpolarizing hologram substrate 54, a second surface 54a of the nonpolarizing hologram substrate 54 facing the semiconductor laser apparatus 64, a third surface 54b of the nonpolarizing hologram substrate 54 facing the optical coupling layer 55, a fourth surface 55a of the optical coupling layer 55 facing the nonpolarizing hologram substrate 54, a fifth surface 55b of the optical coupling layer 55 facing the polarizing hologram substrate 56, and a sixth surface 56a of the polarizing hologram substrate 56 facing the optical coupling layer 55 are plane surfaces, respectively, and are mutually parallel. Moreover, the respective optical axes L11, L22 of the laser light beams emitted from the first and second semiconductor laser devices 51, 52, respectively, are perpendicular to the first to sixth surfaces 63a, 54a, 54b, 55a, 55b, 56a.

By applying a light transmitting adhesive such as an ultraviolet cure resin to a corner portion where the peripheral region of the semiconductor laser apparatus 64 and an outer peripheral surface of the nonpolarizing hologram substrate 54, the surface facing the peripheral region of the semiconductor laser apparatus 64, cross each other, and irradiating with ultraviolet rays, it is possible to adhere the semiconductor laser apparatus 64 and the nonpolarizing hologram substrate 54. Moreover, by applying a light transmitting adhesive such as an ultraviolet cure resin to a corner portion where the peripheral region of the nonpolarizing hologram substrate 54 and an outer peripheral surface of the optical coupling layer 55, the surface facing the peripheral region of the nonpolarizing hologram substrate 54, cross each other, and irradiating with ultraviolet rays, it is possible to adhere the nonpolarizing hologram substrate 54 and the optical coupling layer 55. Furthermore, by applying a light transmitting adhesive such as an ultraviolet cure resin to a corner portion where the peripheral region of the optical coupling layer 55 and an outer peripheral surface of the polarizing hologram substrate 56, the surface facing the peripheral region of the optical coupling layer 55, cross each other, and irradiating with ultraviolet rays, it is possible to adhere the optical coupling layer and the second substrate. In the embodiment, the order of placing of the nonpolarizing hologram substrate 54, the optical coupling layer 55 and the polarizing hologram substrate 56 is identical to the order of assembly.

According to the embodiment as described above, by joining the nonpolarizing hologram substrate 54 to one surface in the thickness direction of the cap 63 of the semiconductor laser apparatus 64 in a state where a peripheral region thereof is exposed, joining the optical coupling layer 55 to one surface in the thickness direction of the nonpolarizing hologram substrate 54 in a state where a peripheral region thereof is exposed, and joining the polarizing hologram substrate 56 to one surface in the thickness direction of the optical coupling layer 55 in a state where a peripheral region thereof is exposed, it is possible to secure regions for applying an adhesive in order to adhere the semiconductor laser apparatus 64 and the nonpolarizing hologram substrate 54, adhere the nonpolarizing hologram substrate 54 and the optical coupling layer 55, and adhere the optical coupling layer 55 and the polarizing hologram substrate 56. Therefore, only by applying a light transmitting adhesive such as an ultraviolet cure resin to the secured regions and irradiating with ultraviolet rays, it is possible to easily adhere the semiconductor laser apparatus 64 and the nonpolarizing hologram substrate 54, adhere the nonpolarizing hologram substrate 54 and the optical coupling layer 55, and adhere the optical coupling layer 55 and the polarizing hologram substrate 56, whereby it is possible to facilitate an adhering operation.

In the embodiment, by interposing the optical coupling layer 55 realized by silica glass, acrylic resin or the like between the respective surfaces of the nonpolarizing hologram substrate 54 and the polarizing hologram substrate 56, the surfaces facing each other, it is possible to prevent that, for example, when a laser light beam whose oscillation wavelength is 650 nm is emitted from the first semiconductor laser device 51, light diffracted by the polarizing hologram diffraction grating 59 formed on the polarizing hologram substrate 56 enters and is diffracted by the nonpolarizing hologram diffraction grating 58 formed on the nonpolarizing hologram substrate 54. Moreover, at the time of executing an optical adjustment such as an optical axis adjustment for light beams of plural wavelength bands by using the polarizing hologram diffraction grating 59, it is possible, by mounting and fixing the optical coupling layer 55 on the nonpolarizing substrate 54 in advance, to prevent that the nonpolarizing hologram diffraction grating 58 formed on the nonpolarizing hologram substrate 54 is damaged by, for example, a rotating movement of the polarizing hologram substrate 56.

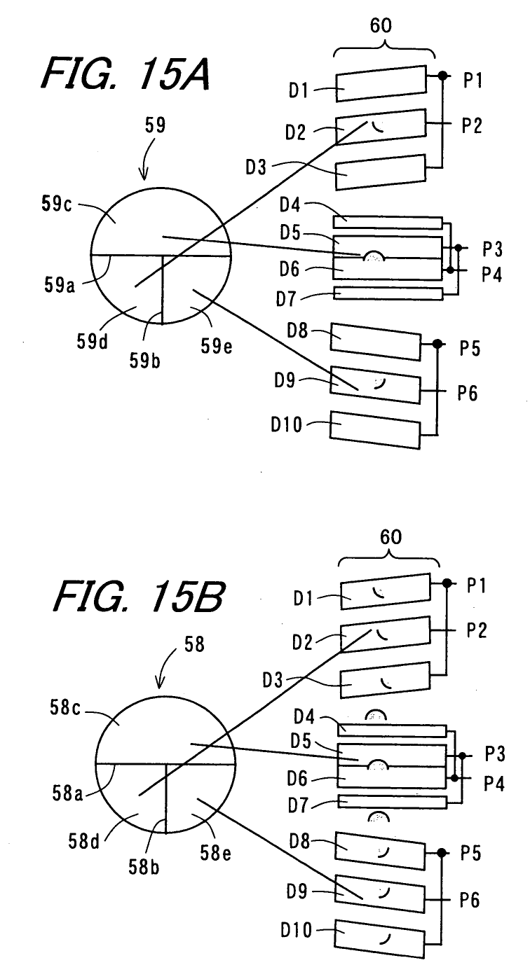

FIGS. 15A and 15B are views showing the nonpolarizing hologram diffraction grating 58 and the polarizing hologram diffraction grating 59, and the light receiving device 60 for receiving light beams diffracted by the nonpolarizing hologram diffraction grating 58 and the polarizing hologram diffraction grating 59, respectively. FIG. 15A is a view showing the polarizing hologram diffraction grating 59 and an example of spot shapes of light beams obtained when reflection light by the optical recording medium 76 of a laser light beam emitted from the first semiconductor laser device 51 is diffracted by the polarizing hologram diffraction grating 59 and enters the light receiving device 60. FIG. 15B is a view showing the nonpolarizing hologram diffraction grating 58 and an example of spot shapes of light beams obtained when reflection light by the optical recording medium 76 of a laser light beam emitted from the second semiconductor laser device 52 is diffracted by the nonpolarizing hologram diffraction grating 58 and enters the light receiving device 60.

The polarizing hologram diffraction grating 59 shown in FIG. 15A diffracts the light beam emitted from the first semiconductor laser device 51 and reflected by the information recording surface of a DVD, and guides the diffracted light beam to the light receiving device 60. The nonpolarizing hologram diffraction grating 58 shown in FIG. 15B diffracts the light beam emitted from the second semiconductor laser device 52 and reflected by the information record surface of a CD, and guides the diffracted light beam to the light receiving device 60.

In order to detect an output signal obtained when the spot shapes of the light beams on the light receiving device 60 change with relative movement of the optical recording medium 76 and the objective lens 75, and keep a space between the optical recording medium 76 and the objective lens 75 fixed, it is necessary to divide the polarizing hologram diffraction grating 59 and the nonpolarizing hologram diffraction grating 58 into at least two grating regions, respectively. As shown in FIG. 15A, the polarizing hologram diffraction grating 59 of the embodiment is formed into a circular shape, and has a first grating region 59c, a second grating region 59d and a third grating region 59e. The first grating region 59c is one of two semicircular regions obtained by dividing a circular region with a first division line 59a. The second grating region 59d is one of two quarter-circular regions obtained by dividing the other semicircular region of the two semicircular regions with a second division line 59b which is perpendicular to the first division line 59a. The third grating region 59e is the other of the two quarter-circular regions.

Further, as shown in FIG. 15B, the nonpolarizing hologram diffraction grating 58 of the embodiment is formed into a circular shape, and has a first grating region 58c, a second grating region 58d and a third grating region 58e. The first grating region 58c is one of two semicircular regions obtained by dividing a circular region with a first division line 58a. The second grating region 58d is one of two quarter-circular regions obtained by dividing the other semicircular region of the two semicircular regions with a second division line 58b which is perpendicular to the first division line 58a. The third grating region 58e is the other of the two quarter-circular regions.

The light receiving device 60 has a plurality of light receiving regions for receiving light beams respectively diffracted by the first grating regions 59c, 58c, the second grating regions 59d, 58d and the third grating regions 59e, 58e of the polarizing hologram diffraction grating 59 and the nonpolarizing hologram diffraction grating 58. The light receiving device 60 of the embodiment has ten light receiving regions D1 to D10 as shown in FIGS. 15A and 15B. The respective light receiving regions D1 to D10 are selectively used for reading information of a CD and a DVD and detecting an FES, a TES and a reproduction signal (abbreviated as RF) Further, the light receiving device 60 is disposed in a manner that longitudinal directions of the respective light receiving regions D1 to D10 become parallel to diffraction directions by the polarizing hologram diffraction grating 59 and the nonpolarizing hologram diffraction grating 58. The respective light receiving regions D1 to D10 are formed in a manner that lengths in the longitudinal directions become longer than a range of variation of entering positions due to variation of the wavelengths of the first and second semiconductor laser devices 51, 52 serving as the light sources. Thus, even when the wavelengths of the first and second semiconductor laser devices 51, 52 vary because of a change in temperature or the like, it is possible to securely receive the light beams and acquire desirable signals. Moreover, since capacitance increases and response speeds of the respective light receiving regions D1 to D10 decrease in a case where the lengths in the longitudinal directions of the respective light receiving regions D1 to D10 are made to be excessively long, the light receiving device 60 is formed so as to have lengths such that the capacitance does not influence on the response speeds.

In the embodiment, in the case of detecting an FES necessary for reading information of a DVD and a CD, the knife-edge method is used. Moreover, in the embodiment, in the case of detecting a TES necessary for reading information of a DVD, the Differential Phase Detection (abbreviated as DPD) method is used, and in the case of detecting a TES necessary for reading information of a CD, the Differential Push-pull (abbreviated as DPP) method is used.

In FIGS. 15A and 15B, RFs of a CD and a DVD are detected on the basis of output signals of the light receiving regions D2, D4, D5, D6, D7, D9. Moreover, a TES of a DVD based on the DPD method is detected on the basis of the output signals of the light receiving regions D2, D9. A high response speed is demanded of the light receiving regions for detecting such signals as an RF and a TES based on the DPD method, which contain high-frequency components and require rapid reading of reproduction signals of the optical recording medium 76 as described above.

Furthermore, a TES of a CD is detected on the basis of output signals of the light receiving regions D1, D3, D8, D10, and FESs of a CD and a DVD are detected on the basis of the output signals of the light receiving regions D4, D5, D6, D7. A high response speed is not demanded of the light receiving regions D1, D3, D8, D10 for detecting a TES of a CD. Moreover, a high response speed is not demanded of the light receiving regions D4, D7, because these light receiving regions are for countervailing a stray light to an FES caused at the time of reading from a DVD, which is a two-layer disk, and light does not enter these regions during reproduction of signals.

In FIGS. 15A and 15B, in order to reduce the number of output terminals of the hologram laser unit 65, the light receiving regions for detecting the same signal may be internally connected. For example, in the embodiment, it is possible to internally connect the light receiving region D4 and the light receiving region D6, and connect the light receiving region D5 and the light receiving region D7, which are for detecting an FES, respectively. Moreover, it is possible to internally connect the light receiving region D1 and the light receiving region D3, and connect the light receiving region D8 and the light receiving region D10, which are for detecting a TES based on the DPP method, respectively. In FIGS. 15A and 15B, an output signal when the light receiving region D1 and the light receiving region D3 are internally connected is denoted by P1, an output signal when the light receiving region D5 and the light receiving region D7 are internally connected is denoted by P3, an output signal when the light receiving region D4 and the light receiving region D6 are internally connected is denoted by P4, and an output signal when the light receiving region D8 and the light receiving region D10 are internally connected is denoted by P5. Moreover, the output signals of the light receiving regions D2, D6 are denoted by P2, P6, respectively.

An FES, a TES and an RF based on the signals obtained when light reflected on the information recording surface of a DVD is diffracted by the polarizing hologram diffraction grating 59, received by the respective light receiving regions D1 to D10 of the light receiving device 60 and outputted from the respective light receiving regions D1 to D10 are found by the aforementioned expressions (1) to (3), respectively. An FES, a TES and an RF based on the signals obtained when light reflected on the information recording surface of a CD is diffracted by the nonpolarizing hologram diffraction grating 58, received by the respective light receiving regions D1 to D10 of the light receiving device 60 and outputted from the respective light receiving regions D1 to D10 are found by the aforementioned expressions (4) to (6) respectively.

As described above, the knife-edge method is used for detecting an FES necessary for reading information of a DVD and a CD, the DPD method is used for detecting a TES necessary for reading information of a DVD, and the DPP method is used for detecting a TES necessary for reading information of a CD in the light receiving device 60 shown in FIGS. 15A and 15B, however, a spot size method may be used for detection of an FES necessary for reading information of a DVD and a CD, the DPP method may be used for detection of a TES necessary for reading information of a DVD, and the DPP method may be used for detection of a TES necessary for reading information of a CD, for example.

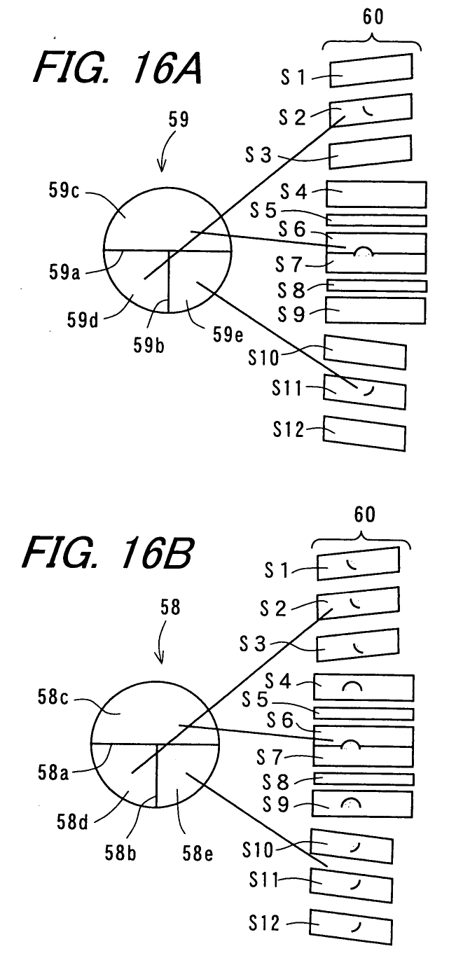

FIGS. 16A and 16B are views showing the nonpolarizing hologram diffraction grating 58 and the polarizing hologram diffraction grating 59, and the light receiving device 60 for receiving light beams diffracted by the nonpolarizing hologram diffraction grating 58 and the polarizing hologram diffraction grating 59, respectively. FIG. 16A is a view showing the polarizing hologram diffraction grating 59 and an example of spot shapes of light beams obtained when reflection light by the optical recording medium 76 of the laser light beam emitted from the first semiconductor laser device 51 is diffracted by the polarizing hologram diffraction grating 59 and enters the light receiving device 60. FIG. 16B is a view showing the nonpolarizing hologram diffraction grating 58 and an example of spot shapes of light beams obtained when reflection light by the optical recording medium 76 of the laser light beam emitted from the second semiconductor laser device 52 is diffracted by the nonpolarizing hologram diffraction grating 58 and enters the light receiving device 60.

The polarizing hologram diffraction grating 59 shown in FIG. 16A diffracts the light beam emitted from the first semiconductor laser device 51 and reflected by the information recording surface of a DVD, and guides the diffracted light beam to the light receiving device 60. The nonpolarizing hologram diffraction grating 58 shown in FIG. 16B diffracts the light beam emitted from the second semiconductor laser device 52 and reflected by the information recording surface of a CD, and guides the diffracted light beam to the light receiving device 60. Since the polarizing hologram diffraction grating 59 and the nonpolarizing hologram diffraction grating 58 shown in FIGS. 16A and 16B, respectively, have the same shapes and functions as the polarizing hologram diffraction grating 59 and the nonpolarizing hologram diffraction grating 58 shown in FIGS. 15A and 15B, respectively, corresponding portions will be denoted by the same reference numerals, and a description thereof will be omitted.

The light receiving device 60 shown in FIGS. 16A and 16B has a plurality of light receiving regions for receiving light beams respectively diffracted by the first grating regions 59c, 58c, the second grating regions 59d, 58d and the third grating regions 59e, 58e of the polarizing hologram diffraction grating 59 and the nonpolarizing hologram diffraction grating 58. The light receiving device 60 of the embodiment has twelve light receiving regions S1 to S12 as shown in FIGS. 16A and 16B. The respective light receiving regions S1 to S12 are selectively used for reading information of a CD and a DVD and detecting an FES, a TES and an RF.

In FIGS. 16A and 16B, the knife-edge method is used for detection of an FES necessary for reading information of a DVD and a CD. Moreover, the DPD method is used for detection of a TES necessary for reading information of a DVD, and the three-beam method is used for detection of a TES necessary for reading information of a CD.

In FIGS. 16A and 16B, RFs of a CD and a DVD are detected on the basis of output signals of the light receiving regions S2, S5, S6, S7, S8, S11. Further, a TES of a DVD based on the DPD method is detected on the basis of the output signals of the light receiving regions S2, S11. Furthermore, a TES of a CD is detected on the basis of output signals of the light receiving regions S1, S3, S4, S9, S10, S12. A high response speed is not demanded of the light receiving regions S5, S8, because these light receiving regions are for countervailing a stray light to an FES caused at the time of reading information of a DVD, which is a two-layer disk, and light does not enter these regions during reproduction of signals.

Although the state of internally connecting the light receiving regions for detecting the same signal is not shown in FIGS. 16A and 16B, the light receiving regions may be internally connected in the same manner as in FIGS. 15A and 15B in order to reduce the number of the output terminals of the hologram laser unit 65. For example, in the embodiment, it is possible to internally connect the light receiving region S5 and the light receiving region S7, and connect the light receiving region S6 and the light receiving region S8, which are for detecting an FES, respectively. Moreover, it is possible to internally connect the light receiving region S1, the light receiving region S4 and the light receiving region S10, and connect the light receiving region S3, the light receiving region S9 and the light receiving region S12, which are for detecting a TES based on the three-beam method, respectively.

An FES, a TES and an RF based on the signals obtained when light reflected on the information recording surface of a DVD is diffracted by the polarizing hologram diffraction grating 59, received by the respective light receiving regions S1 to S12 of the light receiving device 60 and outputted from the respective light receiving regions S1 to S12 are found by the aforementioned expressions (7) to (9), respectively. An FES, a TES and an RF based on the signals obtained when light reflected on the information recording surface of a CD is diffracted by the nonpolarizing hologram diffraction grating 58, received by the respective light receiving regions S1 to S12 of the light receiving device 60 and outputted from the respective light receiving regions S1 to S12 are found by the aforementioned expressions (10) to (12) respectively.

As described above, the knife-edge method is used for detection of an FES necessary for reading information of a DVD and a CD, the DPD method is used for detection of a TES necessary for reading information of a DVD, and the three-beam method is used for detection of a TES necessary for reading information of a CD in the light receiving device 60 shown in FIGS. 16A and 16B, however, the spot size method may be used for detection of an FES necessary for reading information of a DVD and a CD, and the DPP method may be used for detection of a TES necessary for reading information of a DVD and a CD, for example.

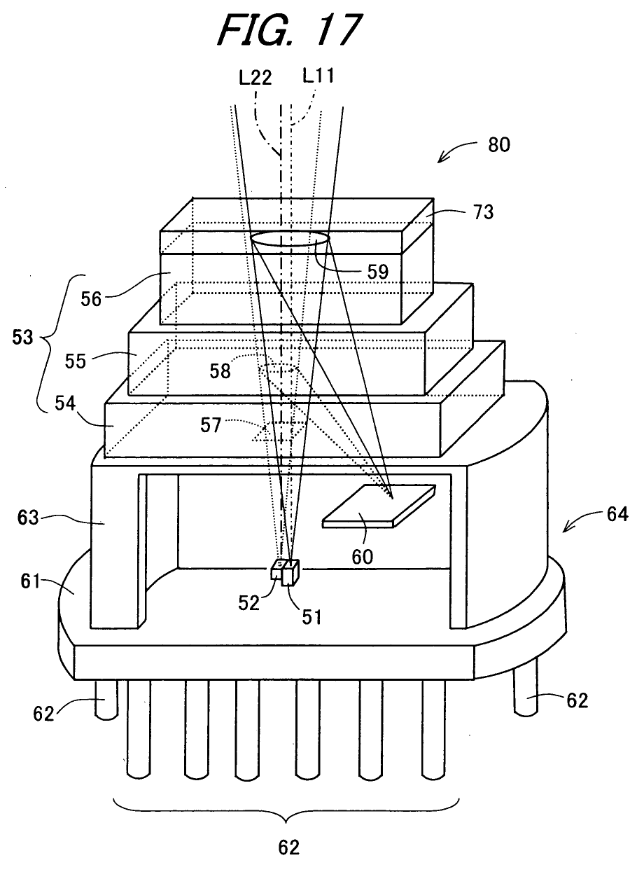

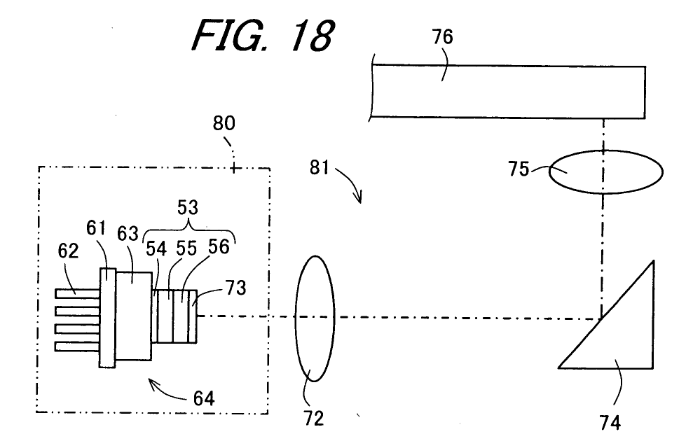

FIG. 17 is a simplified perspective view showing a structure of a hologram laser unit 80 comprising the hologram coupled member 53, which is still another embodiment of the invention. FIG. 18 is a simplified view showing a structure of an optical pickup apparatus 81. In FIG. 17, the cap 63 is partially cut away to show. Since the hologram laser unit 80 is similar to the hologram laser unit 65 in the optical pickup apparatus 71 described above, and the hologram laser unit 80 has the same structure and function as the hologram laser unit 65 except that the 5λ/4 plate 73 is integrally formed on the hologram coupled member 53, corresponding portions will be denoted by the same reference numerals, and descriptions of the same structure and function as those of the hologram laser unit 65 will be omitted. The optical pickup apparatus 81 is an apparatus which executes at least one of a process of optically reading information recorded on the information recording surface of the optical recording medium 76 and a process of optically recording information on the information recording surface of the optical recording medium 76.

Although the 5λ/4 plate 73 is placed between the collimation lens 72 and the erecting mirror 74 in the optical pickup apparatus 71 shown in FIG. 13, the 5λ/4 plate 73 is integrated with the hologram coupled member 53 of the hologram laser unit 80 in the optical pickup apparatus 81 shown in FIG. 18. In concrete, the 5λ/4 plate 73 is integrally mounted and structured on one surface portion in the thickness direction of the polarizing hologram substrate 56 of the hologram coupled member 53.

According to the embodiment as described above, by integrating the 5λ/4 plate 73 and the hologram coupled member 53 to structure the hologram laser unit 80, the number of optical components and the number of steps in assembly at the time of manufacture are reduced, and an operation of an optical adjustment such as an optical axis adjustment is simplified. Moreover, in the case of using the hologram laser unit 80 that the number of optical components is reduced, in the optical pickup apparatus 81, it is possible to make the length of an optical path between the hologram laser unit 80 and the erecting mirror 74 to be shorter than in the optical pickup apparatus 71, with the result that it is possible to promote miniaturization of the optical pickup apparatus 81, and it is possible to decrease the cost of manufacture of the optical pickup apparatus 81.

The aforementioned embodiments merely exemplify the invention, and the structure of the invention may be changed within the scope of the invention. For example, although the structures of the hologram coupled members 3, 15, 53, the hologram laser units 14, 40, 65, 80 and the optical pickup apparatuses 21, 41, 71, 81 applied to reading of information of a DVD and a CD and recording of information onto a DVD and a CD are described in the aforementioned embodiments, the invention can also be preferably embodied for not only the aforementioned DVD and CD but also a recordable optical recording medium such as a DVD-R (Digital Versatile Disk-Recordable) and a CD-R (Compact Disk-Recordable) in another embodiment of the invention.

Further, although an ultraviolet cure resin is used as a light transmitting adhesive in the aforementioned embodiments, a thermosetting resin which sets when heated can also be preferably used as a light transmitting adhesive in another embodiment of the invention.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

What is cliamed is:

1. A hologram coupled member comprising:
a first substrate on which a first optical element having a diffraction surface is formed;
a second substrate on which a second optical element having a diffraction surface is formed; and
an optical coupling layer interposed between respective surfaces of the first and second substrates facing each other.

2. The hologram coupled member of claim 1, wherein the first substrate includes an isotropic overcoat layer formed on the diffraction surface of the first optical element; and
the second substrate includes an isotropic overcoat layer formed on the diffraction surface of the second optical element.

3. The hologram coupled member of claim 2, wherein a refraction index of the optical coupling layer is almost equal to a refraction index of the isotropic overcoat layer.

4. A method for manufacturing a hologram coupled member comprising the steps of:
forming a first optical element having a diffraction surface on a first substrate;
forming a second optical element having a diffraction surface on a second substrate; and
interposing an optical coupling layer between respective surfaces of the first and second substrates facing each other.

5. The method of claim 4, further comprising the steps of:
forming an isotropic overcoat layer on the diffraction surface of the first optical element; and
forming an isotropic overcoat layer on the diffraction surface of the second optical element.

6. The method of claim 4, further comprising the step of:
uniformly applying a light transmitting adhesive between the respective surfaces of the first and second substrates facing each other and adhering the first substrate and the second substrate.

7. An optical pickup apparatus comprising:
the hologram coupled member of claim 1,
wherein the first and second optical elements have diffraction characteristics of diffracting reflection light beams of transmission light beams transmitted in one direction to a common region.

8. The optical pickup apparatus of claim 7, further comprising:
a polarizing element which functions as an almost one-quarter wavelength plate for light beams of plural wavelengths.

9. The hologram coupled member of claim 1, wherein the optical coupling layer is made of a light transmitting solid material.

10. The hologram coupled member of claim 1, wherein the first optical element is a nonpolarizing hologram diffraction grating whose diffraction efficiency is nearly constant regardless of a polarization direction of incident light, and the second optical element is a polarizing hologram diffraction grating whose diffraction efficiency varies depending on a polarization direction of incident light.

11. The hologram coupled member of claim 1, wherein the first substrate is joined to a surface of a semiconductor laser apparatus in a state where a peripheral region thereof is exposed, the optical coupling layer is joined to a surface of the first substrate in a state where a peripheral region thereof is exposed, and the second substrate is joined to a surface of the optical coupling layer in a state where a peripheral region thereof is exposed.

12. The hologram coupled member of claim 1, wherein a beam splitting diffraction grating is formed on a surface of the first substrate, the surface being opposite to a surface on which the first optical element is formed.

13. The hologram coupled member of claim 12, wherein the beam splitting diffraction grating splits incident light into one main beam and two sub beams.

14. The hologram coupled member of claim 1, further comprising:
a light transmitting phase difference film which gives different phase differences to respective light beams of first and second wavelength bands,
wherein the phase difference film is integrally formed with the second substrate.

15. A hologram laser unit comprising:
a light source which emits light beams of predetermined plural wavelength bands;
a light receiving device which receives a light beam emitted from the light source and reflected by an optical recording medium; and
the hologram coupled member of claim 9,
wherein the first and second optical elements have a diffraction characteristic such that the optical elements diffract reflection light of transmission light transmitted in one direction, to a specified common region of the light receiving device.

16. An optical pickup apparatus comprising:
a light source which emits light beams of predetermined plural wavelength bands;
condensing means which condenses a light beam emitted from the light source to an optical recording medium;
a light receiving device which receives a light beam condensed to the optical recording medium by the condensing means and reflected by the optical recording medium;
the hologram coupled member of claim 9; and
a light transmitting phase difference film which gives different phase differences to respective light beams of first and second wavelength bands emitted from the light source and transmitted by the hologram coupled member,
wherein the phase difference film is placed between the second substrate and the condensing means.

17. The optical pickup apparatus of claim 16, wherein the beam splitting diffraction grating formed on the first substrate of the hologram coupled member splits incident light into one main beam and two sub beams, and gives a phase difference to one of the sub beams so that the amplitude of a difference signal of the two sub beams becomes nearly zero.
